(19) United States
(12) Patent Application Publication
(10) Pub. No.: US 2014/0067530 A1
(43) Pub. Date: Mar. 6, 2014

(54) SYSTEMS AND METHODS FOR PRECISION RETAILING

(71) Applicants: Herve Pluche, Berkeley, CA (US); Francois Silvain, Winchester, MA (US); Damien Guinan, Offaly (IE); Jean-Yves Cras, Paris (FR)

(72) Inventors: Herve Pluche, Berkeley, CA (US); Francois Silvain, Winchester, MA (US); Damien Guinan, Offaly (IE); Jean-Yves Cras, Paris (FR)

(73) Assignee: SAP AG, Walldorf (DE)

(21) Appl. No.: 13/598,483

(22) Filed: Aug. 29, 2012

(51) Int. Cl. G06Q 30/02

(52) U.S. Cl. CPC G06Q 30/0267
USPC 705/14.53; 705/14.64

(57) ABSTRACT

According to various embodiments, a mobile interaction event corresponding to a user of a mobile device currently accessing product-related content may be detected. Thereafter, real-time interaction data associated with the mobile interaction event is persisted to an interaction data table in real-time. Further, ancillary data may be accessed from one or more ancillary data tables. The ancillary data may be persisted into the ancillary data tables at periodic time intervals. Real-time user context information may be generated, based on the real-time interaction data included in the interaction data table and the ancillary data included in the ancillary data tables.

### TECHNICAL FIELD

The present application relates generally to the technical field of retailing and, in one specific example, to systems and methods for precision retailing.

### BACKGROUND

The basic approach to retailing, or the process of selling products and commodities directly to customers, remains largely unchanged. Consumers typically visit retail stores and browse for various products available for sale in the retail stores, and may decide to purchase some of the various products available for sale in the stores. Moreover, if the consumer has some idea beforehand of the particular products they would like to purchase, the user may collect promotional offers (e.g., coupons and vouchers) regarding such products and bring them to the store, in the hopes that such products are available for sale in the store and that the promotional offer may be applied to purchase such products.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 is a flowchart illustrating an example method, according to various embodiments.

FIG. 4 is a graphical representation of an example of a product-related webpage, according to various embodiments.

FIG. 5 is a graphical representation of various types of information persisted to either an interaction data table or an ancillary data tablet(s), according to various embodiments.

FIG. 6 illustrates an example of as interaction data table, according to various embodiments.

FIG. 7 illustrates an example of an ancillary data table containing user profile information, according to various embodiment.

FIG. 8 illustrates an example of an ancillary data table containing product information, according to various embodiments.

FIG. 9 is a table illustrating an example of real-time user context information, according to various embodiments.

FIG. 10 is a flowchart illustrating an example method, according to various embodiments.

FIG. 11 illustrates an example of an ancillary data table containing promotion information, according to various embodiments.

FIG. 12 illustrates an example of detailed promotion information, according to various embodiments.

FIG. 13 is a table illustrating an example of promotion rating information, according to various embodiments.

FIG. 14 is a flowchart illustrating an example method, according to various embodiments.

FIG. 15 is a table illustrating an example of information regarding a list of a subset of promotions, according to various embodiments.

FIG. 16 is graphical representation of a website illustrating an exemplary list of a subset of promotions, according to various embodiments.

FIG. 17 is a flowchart illustrating an example method, according to various embodiments.

FIG. 18 is a flowchart illustrating an example method, according to various embodiments.

FIG. 19 is a schematic diagram illustrating an example of modifying a list of promotions based on user purchase history, according to various embodiments.

FIG. 20 is a table illustrating an example various user preferences, according to various embodiments.

FIG. 21 is a flowchart illustrating an example methods, according to various embodiments.

FIG. 22 is a schematic diagram illustrating an example of modifying a list of promotions based on user preferences, according to various embodiments.

FIG. 23 is a table illustrating an example of user feedback information, according to various embodiments.

FIG. 24 is a flowchart illustrating an example method, according to various embodiments.

FIG. 25 is a flowchart illustrating an example method, according to various embodiments.

FIG. 26 illustrates an example of an ancillary data table containing site catalog information, according to various embodiments.

FIG. 27 illustrates an example of a user interface, according to various embodiments.

FIG. 28 illustrates an example of suggestion information, according to various embodiments.

FIG. 29 is a flowchart illustrating an example method, according to various embodiments.

FIGS. 30-48 illustrate examples of user interfaces, according to various embodiments.

FIG. 49 is a flowchart illustrating an example method, according to various embodiments.

FIG. 50 is a diagrammatic representation of a machine in the example form of a computer system within which a set of instructions, for causing the machine to perform any one or more of the methodologies discussed herein, may be executed.

### DETAILED DESCRIPTION

Example methods and systems For precision retailing are described. In the following description, for purposes of explanation, numerous specific details are set forth in order to provide a thorough understanding of example embodiments. It will be evident, however, to one skilled in the art that the present invention may be practiced without these specific details.

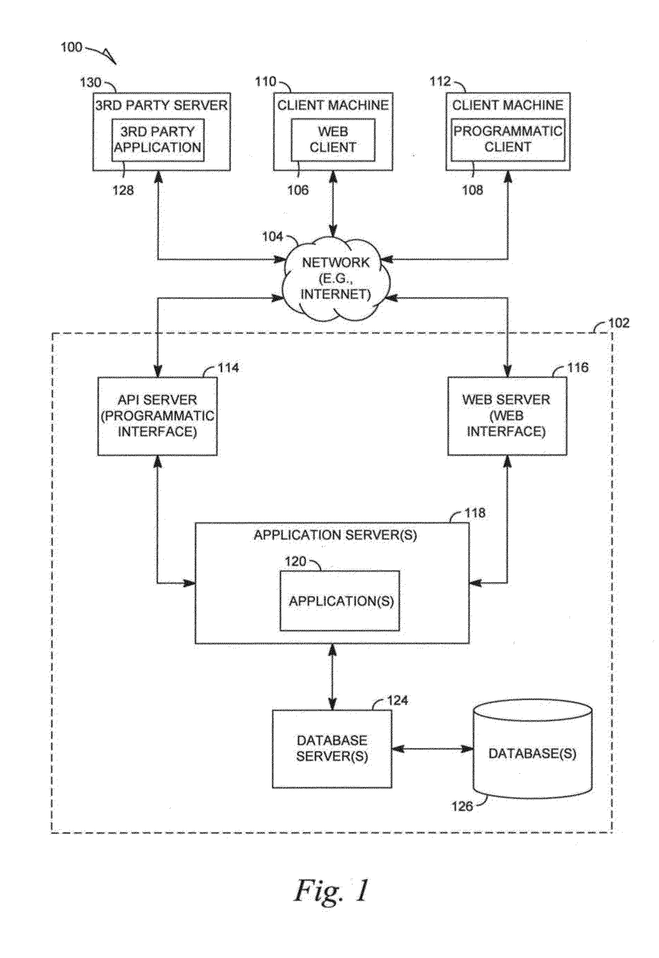

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

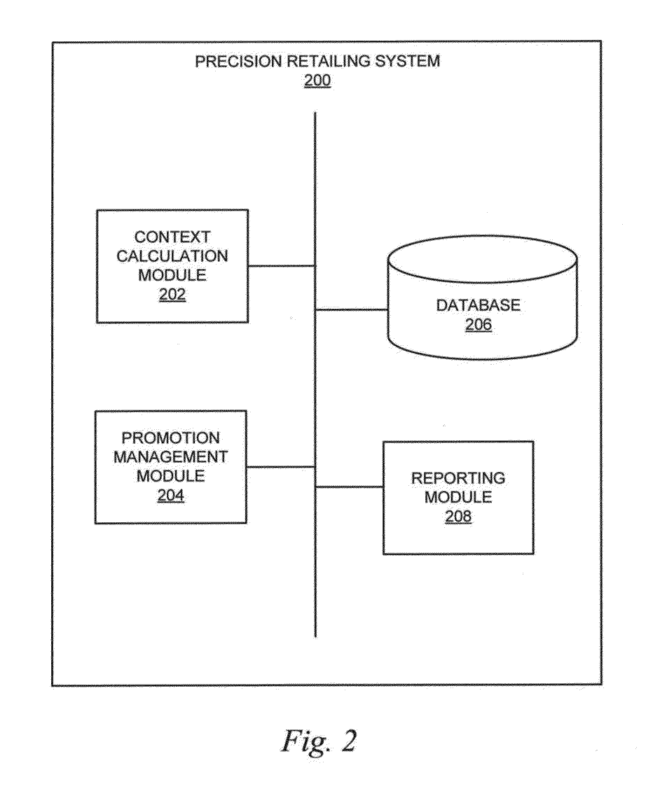

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may correspond to one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a precision retailing system 200 includes a context calculation module 202, a promotion management module 204, a database 206, and a reporting module 208. The modules of the precision retailing system 200 may be implemented on a single device such as a precision retailing device, or on separate devices interconnected via a network. The aforementioned precision retailing device may correspond to, for example, one of the client machines (e.g. 110, 112) or application server(s) 118 illustrated in FIG. 1. The operation of the precision retailing system 200 and the modules thereof is described below with reference to various flowcharts.

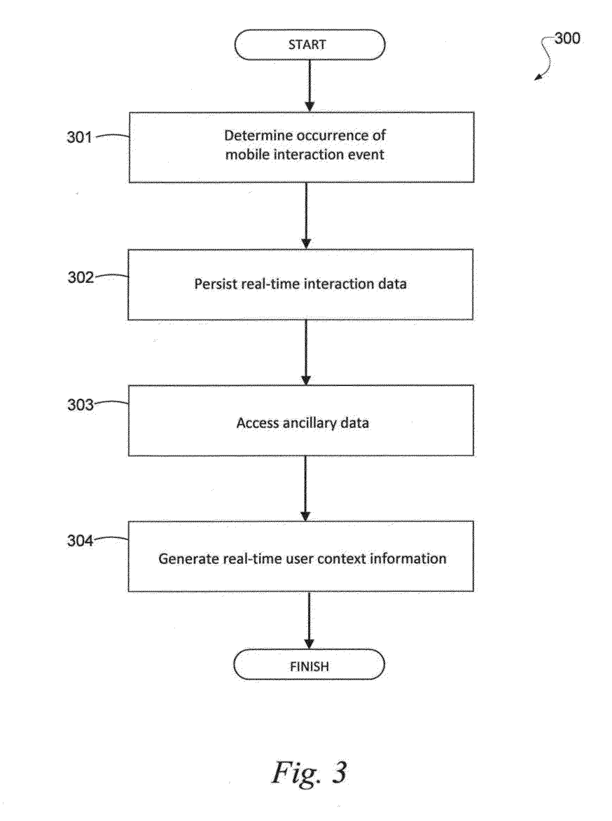

FIG. 3 is a flowchart illustrating an example method 300, according to various embodiments. The method 300 may be performed at least in part by, for example, the precision retailing system 200 illustrated in FIG. 2 (or a precision retailing apparatus having similar modules, such as client machines 110 and 112 or application server 112 illustrated in FIG. 1). In 301, the context calculation module 202 detects a current mobile interaction event corresponding to a user of a mobile device currently accessing product-related content. In 302, the context calculation module 202 persists (e.g., inputs) real-time interaction data associated with the mobile interaction event to an interaction data table in real-time, the real-time interaction data including current time information, current user location information, and interaction event information describing the product-related content accessed by the user. In 303, the context calculation module 202 accesses, from one or more ancillary data tables, ancillary data populated into the ancillary data tables at periodic time intervals, the ancillary data including user profile information-associated with the user and product information associated with a product described in the product-related content. In 304, the content calculation module 202 generates real-time user context information, based on the real-time interaction data included in the interaction data table and the ancillary data included in the ancillary data tables. Each of the aforementioned operations will now be described in greater detail below.

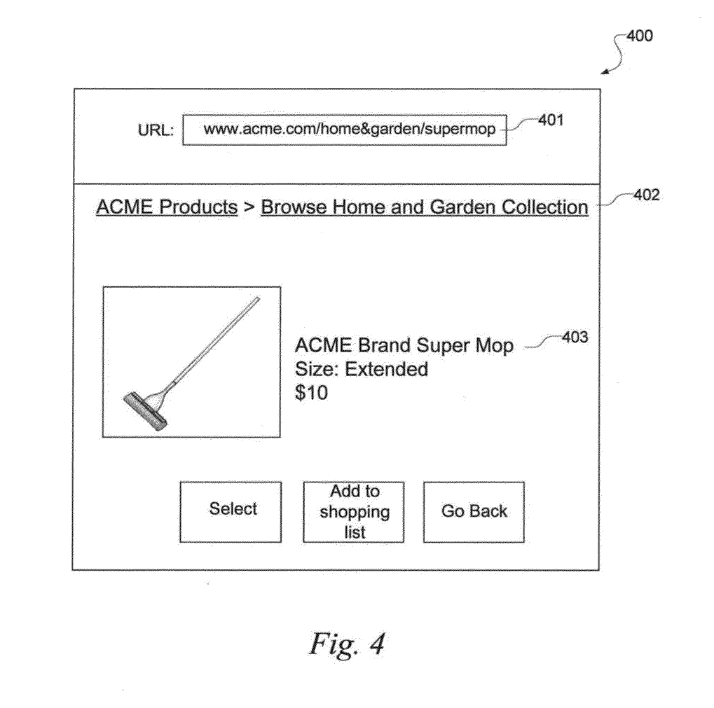

In 301, the context calculation module 202 detects a mobile interaction event corresponding to a user of a client device (e.g., a mobile device) currently accessing product-related content, such as a product-related webpage. The contest calculation module 202 of precision retailing system 200 may determine that a user is currently accessing a product-related webpage by determining that a browser application of the client device associated with the user (e.g., client machines 110 or 112 illustrated in FIG. 1, each of which may correspond to a personal computer, notebook computer, smartphone, tablet, mobile device, etc.) is accessing a URL (Uniform Resource Locator) associated with a product-related webpage via a network (e.g., the Internet). As another example, 202 may determine that a camera unit of the mobile device has taken a photograph of a product, or has scanned a barcode (e.g., a two-dimensional barcode or a QR code) of a product, and an application installed on the mobile device has accessed a product related webpage as a result. A “product-related webpage”, as referred to throughout this disclosure, may be, for example, any webpage referring to or describing a certain product or group of products, any webpage referring to or describing a certain category or categories of products, any webpage corresponding to a retail catalog of products manufactured or sold by a particular business, and so forth. FIG. 4 illustrates an example of a product-related webpage 400 accessed by a client device via URL 401, wherein the product-related webpage 400 describes a particular product (e.g., “ACME Brand Super Mop”, 403). The context calculation module 202 may determine that the accessed webpage is a product-related webpage by, for example, analyzing the URL of the product-related webpage and comparing it to known URLs of product-related webpages, or by performing a textual analysis of words in the webpage and comparing the words against a database of product keywords. Yet another example of an interaction event of the user accessing product-related content includes the user adding an item to a shopping list (e.g., by pressing the “add to shopping list” selection button in the product related webpage 400).

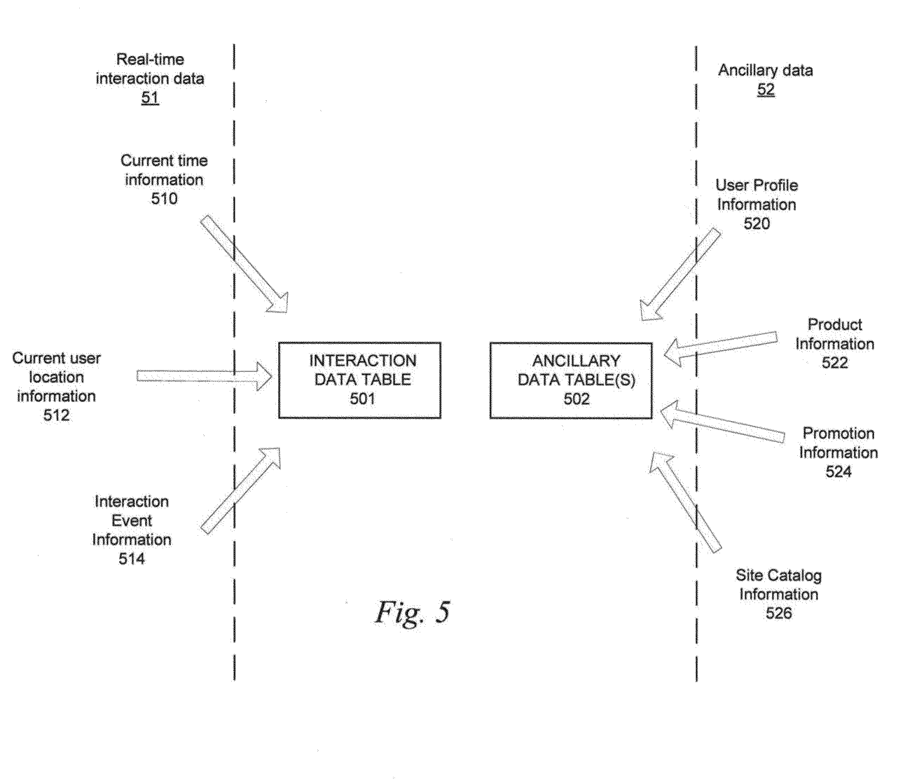

In 302, the context calculation module 202 persists real-time interaction data associated with the mobile interaction event to an interaction data table in real-time. The real-time interaction data may include various information obtained from the user's mobile device, including current time information, current user location information, and interaction event information describing the product-related content accessed by the user. For example, as illustrated in FIG. 5, real-time interaction data 51 including current time information 510, current user location information 512, and interaction event information 514 is persisted in real-time (i.e., instantaneously) into interaction data table 501, as soon as the underlying interaction event is detected. The interaction data table 501 may be located at, for example, database 206 illustrated in FIG. 2, or accessed from a remote device (e.g., web server 116, application server(s) 118 illustrated in FIG. 1).

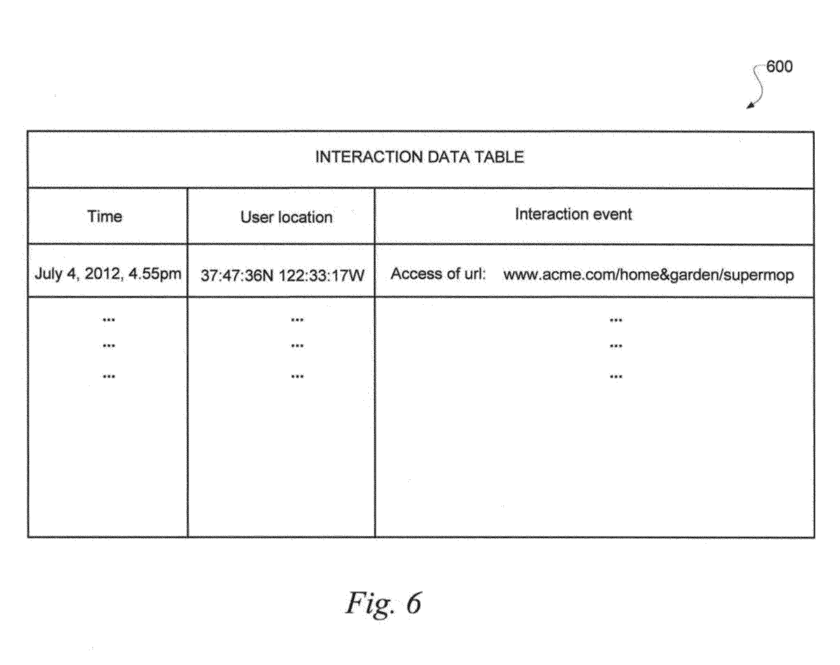

FIG. 6 illustrates an example of an interaction data table 600 including real-time interaction data describing a current interaction event between the user and the mobile device, including:

(1) Current time information, including a current date and time (e.g., “Jul. 4, 2012, 4.55 pm” as seen in FIG. 6), where such current time information may be accessed from the mobile device.

(2) User location information indicating a current location of the user, which may be street address, site location, business name, or Global Positioning System (GPS) co-ordinates (e.g., “37:47:36 N. 122:33:17 W.” as illustrated in FIG. 6) obtained from a GPS system of the user's mobile device. The location of the user may be determined based on other methods (e.g., proximity to nearby RFID tags/readers, signal strength of signals from nearby telecommunications towers, etc.), as understood by those skilled in the art.

(3) interaction event information describing the underlying product-related content accessed by the user. For example, as illustrated in FIG. 6, the interaction event information may state that the user has accessed a particular URL of a particular product related webpage. As other examples, the interaction event information may indicate that the user has viewed a particular product related webpage, selected a particular product displayed in a particular webpage, scanned the bar code of a particular product, taken a photograph of a particular product, added a particular product to a particular shopping list, and so forth.

Referring back to FIG. 3, in 303, the context calculation module 202 accesses ancillary data from one or more ancillary data tables. The ancillary data may include various information including, for example, user profile information associated with the user, and product information associated with a product described in the product-related content that was accessed by the user. For example, as illustrated in FIG. 5, ancillary data 52 including user profile information 520, product information 522, promotion information 524, and site catalog information 525 is populated into ancillary data tables 502 at periodic time intervals. The ancillary data tables 502 may be located at, for example, database 206 illustrated in FIG. 2, or accessed from a remote device (e.g., web server 116, application server(s) 118 illustrated in FIG. 1). The ancillary data may be obtained from various sources (e.g., an application server 118 or Web server 116 illustrated in FIG. 1, or database 206 illustrated in FIG. 2) and persisted/populated into the ancillary data tables at periodic time intervals (e.g., in the form of regular updates). Thus, while the real-time interaction data 51 is persisted into the interaction data table 501 in real-time, the ancillary data 52 need not be persisted into the ancillary data tables 502 in real-time.

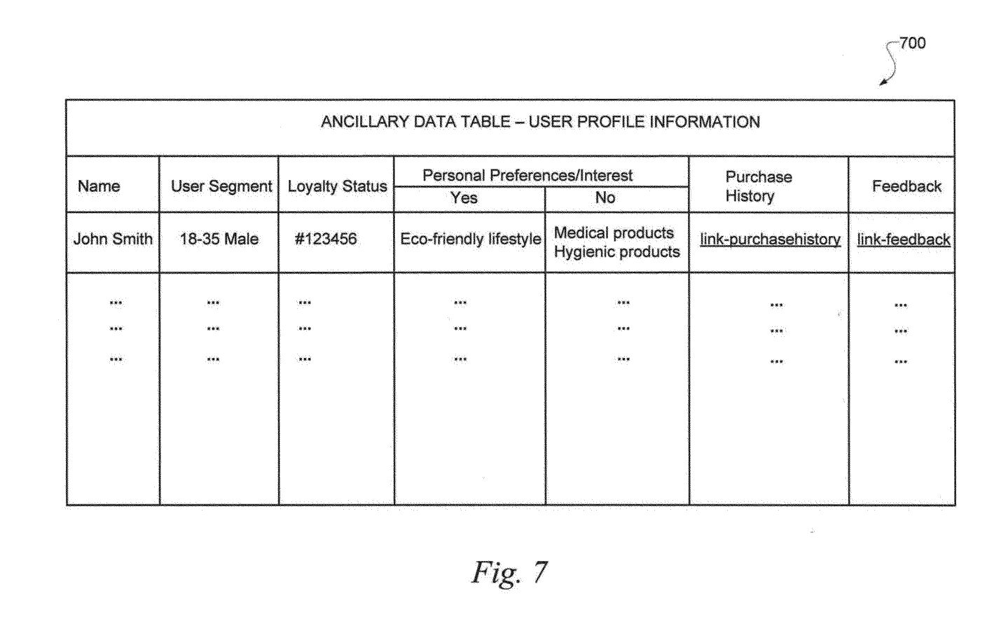

FIG. 7 illustrates an example of one of the ancillary data tables 502 that contains user profile information 700 for one or more users. As seen in FIG. 7, an entry in the user profile information 700 corresponding to a particular user may include various information from a biographical profile (such as a customer relationship management (CRM) profile) of the user, including name (e.g. “John Smith” in FIG. 7), user/consumer segment information (e.g., “18-35 Male” in FIG. 7), and loyalty status (e.g., “Loyalty Card #123456” in FIG. 7). The user profile information may also include personal preferences/interests of the user (e.g., Yes: eco-friendly lifestyle, No: medical products, hygienic products, as seen in FIG. 7), user purchase history information, and user feedback information, which are described in more detail below. The user profile information may include other information (e.g., age, address, phone number, e-mail address, social media username, etc.), as understood by those skilled in the art.

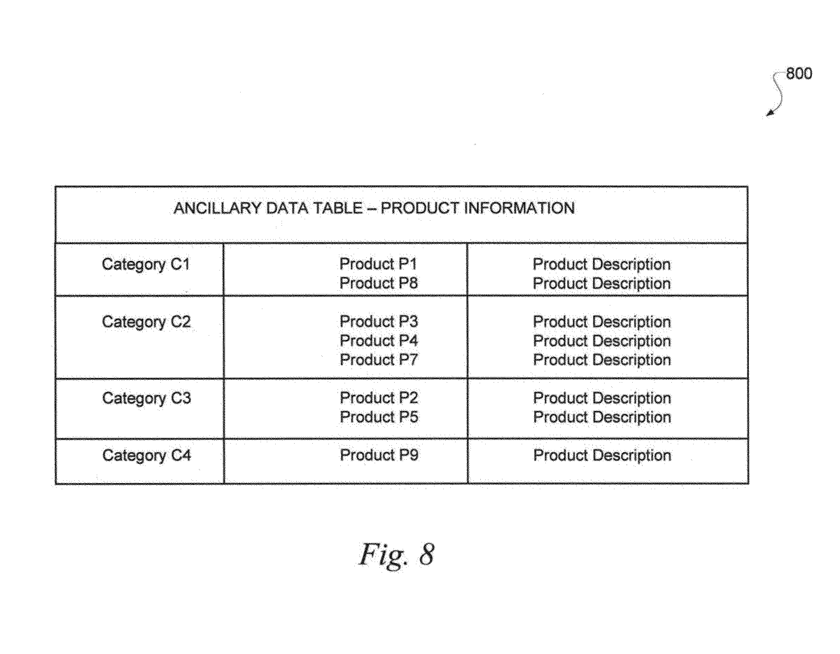

FIG. 8 illustrates an example of one of the ancillary data tables 502 that contains product information 800 for multiple product categories and products. As seen in FIG. 8, the product information may indicate various product categories, where a product category is any retail category, classification or field with which a product may be associated. Non-limiting examples of product categories include: Kids and Family, Health Beauty; Electronics; Entertainment; Recreational and Sport; Grocery; Home and Garden; Auto; Pet; Clothing; etc. Other product categories may exist, as understood by these skilled in the art. The product information 800 of FIG. 8 also identifies products corresponding to each product category, and product descriptions of each of the products.

Now, referring back to FIG. 3, in 304, the context calculation module 202 generates real-time user context information, based on the real-time interaction data included in the interaction data table (e.g., the current time information 510, the current user location information 512, and the interaction event information 514 included in the interaction data table 501) and the ancillary data included in the ancillary data tables (e.g., the user profile information 520 and the product information 522 included in the ancillary data tables 502).

The “real-time user context information”, as described throughout this disclosure, is an amalgamation of various data that provides a holistic real-time overview of a user's current interest (e.g., a user's interest in specific products or product categories), based on a user's current interaction with a computing device displaying information regarding specific products or product categories. As described in more detail below, the real-time user context information may include or may be generated based on various information, including the aforementioned current time information and current user location information (e.g., see FIG. 6), user profile information (e.g., see FIG. 7), and product information describing content included in the product-related webpage accessed by the user.

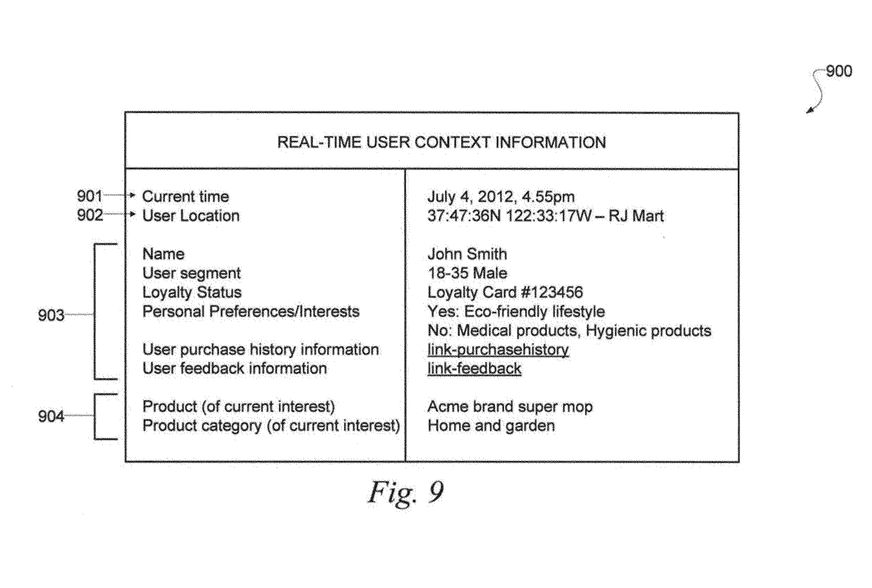

FIG. 9 illustrates as example of real-time user context information 900. The information 900 includes various data describing a current interaction event between the user and a computing device, including:

(1) “When”=current time context information (901), which may be similar to (or generated based on) the current time information included in the real-time interaction data of the interaction data table 600 illustrated in FIG. 6.

(2) “Where”=user location context information (902), which, may be generated based on the current user location information included in the real-time interaction data of the interaction data table 600 illustrated in FIG. 6.

(3) “Who”=user profile context information of the user (903), which may be similar to (or generated based on) the user profile information included in the ancillary data table 700 illustrated in FIG. 7. The user profile context information 903 may include other information, as understood by those skilled in the art.

(4) “What”=product context information (904) describing the products in the product-related content accessed by the user. For example, if the user accessed the product related webpage 400 illustrated in FIG. 4, the product context information 904 may indicate various products (e.g., “Acme brand super mop” in FIG. 4) and/or product categories (e.g., “Home and garden” in FIG. 4) that are the object of the user's current interest (e.g., that are identified in the product-related webpage currently being viewed by the user).

The product context information 904 included in the real-time user context information 900 may be generated in various ways. For example, the context calculation module 202 may access the product-related webpage 400 in FIG. 4 by accessing a URL 401 of the webpage, and crawl through all the data, metadata or information associated with the product-related webpage. As described above, the product information 800 (see FIG. 8) in the ancillary data indicates various categories, and products corresponding to each of the categories, such as products P1 and P8 corresponding to category C1 and so forth. The context calculation module 202 may perform a textual search of all the text included in the product-related webpage 400 to identify any references to one of the products or product categories included in the product information 800, to thereby generate the product context information 904 included in the real-time user contest information 900. For example, with reference to webpage 400 of FIG. 4, the context calculation module 202 may detect the references to the product “ACME Brand Super Mop” (403) and the product category “Home and Garden” (402) in the webpage 400, and thereby generate the product context information 904 included in the real-time user context information 900 seen in FIG. 9.

While the exemplary product-related webpage 400 of FIG. 4 includes references to both a product (e.g., “ACME Brand Super Mop”) and a product category (e.g., “Home and Garden”), it should be understood that the product-related webpage 400 may include references to only a product and not a product category, or vice versa. In such cases, after identifying a given product in the product-related webpage 400, the context calculation module 202 may identify a product category corresponding to the given product. For example, with reference to the product information 800 of FIG. 8, if the context calculation module 202 detects a description of a particular product P7 in the product-related webpage, then the context calculation module 202 may determine that a product category C2 is associated with the particular product P7. Conversely, after identifying a given product category in the product-related webpage 400, the system may identify various products corresponding to the given product category. For example, if the context calculation module 202 detects a description of a particular product category C3 in the product-related webpage, then the context calculation module 202 may access the product information 800 to determine that products P2 and P5 are associated with the particular product category C3.

The product context information 904 included in the real-time user context information 900 may be generated in other possible ways. According to another embodiment, the context calculation module 202 may analyze the URL of the product-related webpage (e.g., the URL 401 in FIG. 4) and compare it to known URLs of known product-related webpages that are associated with particular known products (e.g., the “ACME Brand Super Mop”) and/or known product categories (e.g., “Home and Garden”). A database structure listing such known URLs of known product-related webpages that are associated with particular known products and/or known product categories may be stored in database 206, or accessed from a remote device (e.g., web server 116, application server(s) 118 illustrated in FIG. 1). According to another embodiment, the context calculation module 202 may analyze a barcode scanned by the user's mobile device and compare it to known bar codes of known products (e.g., the “ACME Brand Super Mop”) and/or known product categories (e.g., “Home and Garden”). For example, the product descriptions in the product information 800 illustrated in FIG. 8 may include barcode information of each of the products. According to another embodiment, the context calculation module 202 may analyze a picture scanned or received (or a photograph captured) by the user's mobile device, and compare it to known images of known products (e.g., the “ACME Brand Super Mop”) and/or known product categories (e.g., “Home and Garden”). For example, the product descriptions in the product information 800 illustrated in FIG. 8 may include visual information of each of the products.

Thus, according to various exemplary embodiments, the precision retailing system 200 is able to generate real-time user context information that provides a holistic real-time overview of a user's current interest (e.g., the user's interest in specific products or product categories), based on a user's current interaction with a mobile device. As described above, the real-time user context information is generated based on a mix of the real-time interaction data 51 (which may be obtained from the user's mobile device in real-time-and may describe the user's current interaction with the mobile device), as well as ancillary data 52 (e.g., user profile information and product information) that is obtained in advance and not in real-time. Since the ancillary data 52 may be obtained in advance of the user's interaction with the mobile device, the ancillary data 52 may represent older information, and hence this ancillary data 52 may be referred to as “slow-moving dimensional data”, in contrast to the real-time interaction data 51 that is obtained in real-time.

Accordingly, since the ancillary data 52 is not accessed and populated into the ancillary data table 502 in real-time, and since only the interaction data 51 is persisted in real-time into the interaction data table 501, the total costs of operation—in terms of power usage, resources, time, and money—is greatly reduced. Applicants have determined that attempting to generate the real-time context information based on real-time interaction data as well as ancillary data obtained in real-time may be incredibly time-consuming and unreasonably costly.

### Promotion Management

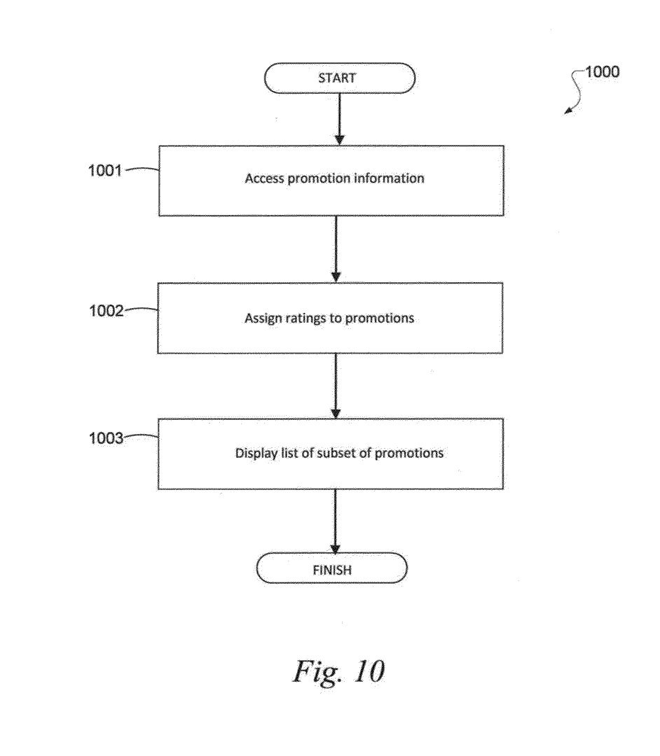

Turning now to FIG. 10, there is illustrated a flowchart of an example method 1000, according to various embodiments. The method 1000 may be performed at least in part by, for example, the precision retailing system 200 illustrated its FIG. 2 (or an apparatus having similar modules, such as client machines 110 and 112 or application server 112 illustrated in FIG. 1). In 1001, the promotion management module 204 accesses promotion information included in the ancillary data tables, the promotion information identifying a plurality of promotions. In 1002, the promotion management module 204 assigns a rating to each of the plurality of promotions based on the real-time user context information, the rating for a given promotion indicating a predicted real-time interest of the user in the given promotion. 1003, the promotion management module 204 displays a list of a subset of the promotions on the mobile device, an ordering of the list being determined based on the ratings assigned to the subset of the promotions. Each of the aforementioned operations will now be described in greater detail below.

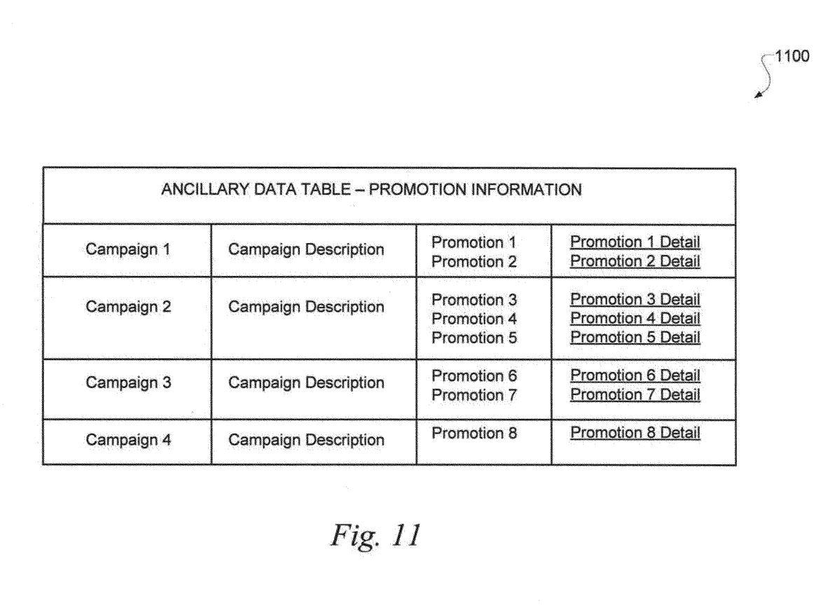

In 1001, the promotion management module 204 accesses promotion information included in the ancillary data of the ancillary data tables. For example, as illustrated in FIG. 5, the ancillary data tables 502 may include promotion information 524, where the promotion information describes a plurality of promotions. FIG. 11 illustrates an example of one of the ancillary data tables 502 that contain promotion information 1100. The promotion information 1100 identifies multiple campaigns, and descriptions of each of the campaigns. As described throughout this disclosure, a campaign may include a collection of promotions and defines the characteristics of their eligibility. These characteristics include validity dates, limits, targeted user segments, targeted site (e.g., stores), conditions, and so on. The promotion information 1100 identifies the individual promotions associated with each campaign (such as, for example, promotions 3, 4, and 5 that are associated with campaign 2), and also includes more detailed information about each promotion, or a link to such information.

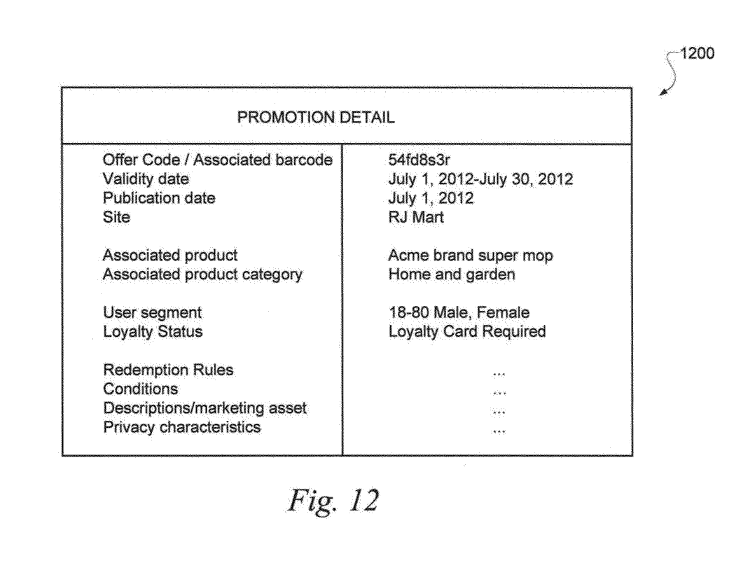

For example, FIG. 12 illustrates a detailed promotion information 1200 describing various information about a particular promotion. The promotions may correspond to vouchers, discounts, deals, etc., associated with various products or product categories. Similar detailed promotion information 1200 may be associated with each promotion, and such information may be included in one of the ancillary data tables 502. The detailed promotion information 1200 associated with a promotion includes: an offer code/associated barcode; a validity date when the promotion is valid; a publication date when the promotion was published, a site where the specific promotion is valid (e.g., a specific store, a specific store type, a specific store at a given hierarchy level and all stores in lower hierarchy level, a specific group of stores (with no dependency); a specific location (GPS) and radius distance; and so forth); an associated product to which the promotion applies; an associated product category to which the promotion applies; a user/consumer segment to which the promotion is targeted; and loyalty status/membership required for the promotion to be valid. For example, as illustrated in FIG. 12, the information associated with the promotion 1200 includes: an offer code/associated barcode of “54fd8s3r”; a validity date of “Jul. 1, 2012-Jul. 30, 2012”; a publication date of “Jul. 1, 2012”, a site of “RJ Mart”; an associated product of “Acme brand super mop”; an associated product category of “Home and garden”; an associated user segment of “18-80 Male, Female”; and loyalty status/membership of “Loyalty Card Required”.

Moreover, the detailed promotion information 1200 associated with each promotion may include: redemption rules that define the value characteristics of the promotion (e.g., this is a Counter, this is a Discount, this is a Cash back, this is a Free item, this is money, this is percentage, this is point, this is value, if you buy Quantity x you get Quantity y free, this is a suggestion for another product, this is a substitution for another product, etc); conditions of the promotion (e.g., only for a specific tough point (channel/module) such as mobile; only for a specific brand; only for a specific product catalog; only for a specific category; only for a specific product family; only for a specific product collection; only for a specific product; only for a minimum quantity; only for a minimum value; only for a minimum total receipt value; only for a minimum total receipt quantity; only if the Campaign/Offer was not already sent, etc.); descriptions/marketing assets (e.g., pictures and video); and privacy characteristics.

Referring back to FIG. 10, in 1002 the context calculation module assigns a rating to each promotion from among a group of promotions, based on the real-time user context information (e.g., 900 in FIG. 9). The rating for a given promotion indicates a predicted real-time interest of the user in the given promotion.

For example, the promotion management module 204 may compare the exemplary detailed promotion information 1200 of a promotion (illustrated in FIG. 12) with the real-time user context information 900 (illustrated is FIG. 9) describing a current mobile interaction event of a user that just happened. Based on this comparison, the promotion management module 204 may predict that the real-time interest of the user in the particular promotion 1200 is high, since the promotion 1200 is valid right now (“Jul. 4, 2012, 4.55 pm”), since the promotion 1200 is valid in the store the user is in right now “RJ Mart”), since the promotion 1200 is related to the same product (“Acme brand super mop”) and product category (“Home and garden”) that is user is apparently interested in right now, since the promotion 1200 is targeted at the same user segment that the user is associated with right now (“18-35 Male”), and since the promotion 1200 requires the same loyalty status that the user has right now (“Loyalty Card #123456”). Accordingly, the promotion management module 204 may assign a fairly high rating to the promotion 1200, where the ratings may range from 0 to 1, for example, with a rating of 0 indicating that the user will probably have little interest in a given promotion, and a rating of 1 indicating that that user will almost certainly like the promotion.

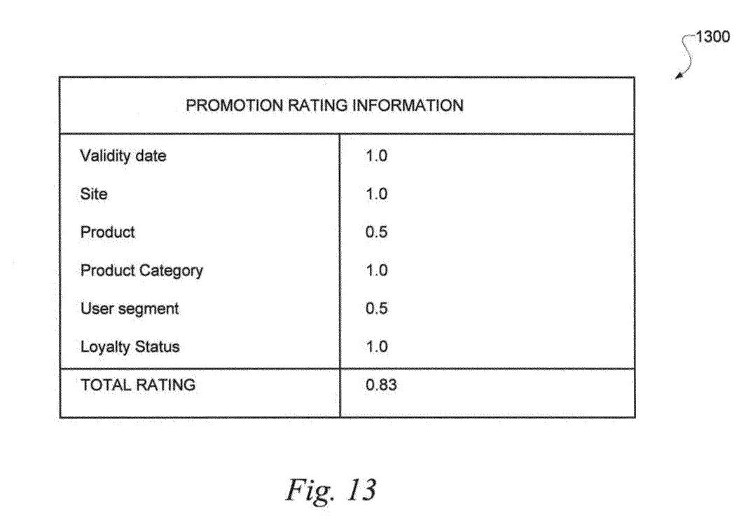

The particular manner in which a specific rating is assigned to a given promotion may vary. According to various embodiments described with reference to promotion rating information 1300 of FIG. 13, the promotion management module 204 may assign: a sub-rating between 0 and 1 based on whether the validity date of the given promotion matches the current time information in the real-time user context information (a sub-rating of 1 indicating a match); a sub-rating between 0 and 1 based on whether the site of the given promotion matches the current user location information in the real-time user context information (a sub-rating of 1 indicating a match); a sub-rating between 0 and 1 based on whether the associated product of the given promotion matches the current product of interest of the user in the real-time user context information (a sub-rating of 1 indicating a match); a sub-rating between 0 and 1 based on whether the associated product category of the given promotion matches the current product category of interest of the user in the real-time user context information (a sub-rating of 1 indicating a match); a sub-rating between 0 and 1 based on whether the associated user segment of the given promotion matches the current user segment of the user in the real-time user context information (a sub-rating of 1 indicating a match); a sub-rating between 0 and 1 based on whether the associated loyalty status of the given promotion matches the current loyalty status of the user in the real-time user context information (a sub-rating of 1 indicating a match); and so forth. As illustrated in FIG. 13, after all the sub-ratings are determined, the average of the sub-ratings may be the total rating assigned to the given promotion.

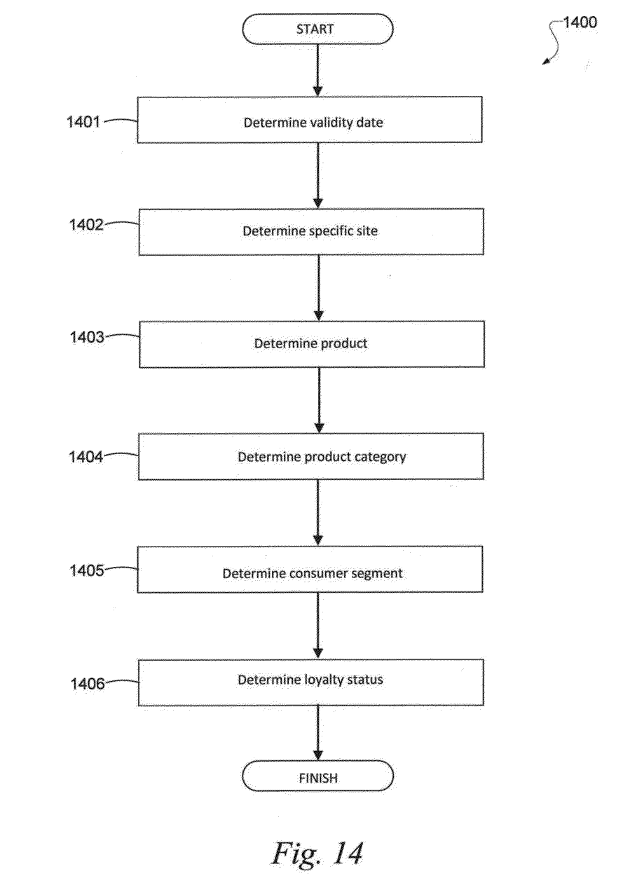

According to another example, the promotion management module 204 may assign a particular rating of 0 to 1 to the promotion, based on whether a particular condition is satisfied; and then repeatedly modify this rating based on whether or not other conditions are also satisfied. For example, FIG. 14 is a flowchart illustrating an example method 1400, according to various embodiments. The method 1400 may be performed at least in part by, for example, the precision retailing system 200 illustrated in FIG. 2 (or a precision retailing apparatus having similar modules, such as client machines 110 and 112 or application server 112 illustrated in FIG. 1).

In 1401, live promotion management module 204 determines that a validity date associated with a specific promotion (e.g., “Jul. 1, 2012-Jul. 20, 2012 in FIG. 12) corresponds to the current time information in the real-time user context information (e.g., “Jul. 4, 2011, 4.55 pm” in FIG. 9). In 1401, the promotion management module 204 also increases the rating assigned to the specific promotion. In 1402, the promotion management module 204 determines that a site associated with the specific promotion (e.g., “RJ Mart” in FIG. 12) corresponds to the current user location information in the real-time user context information (e.g., “RJ Mart” in FIG. 9). In 1402, the promotion management module 204 also increases the rating assigned to the specific promotion. In 1403, the promotion management module 204 determines that a product associated with the specific promotion (e.g., “Acme brand super mop” in FIG. 12) corresponds to a product included in the product information in the real-time user context information (e.g., “Acme brand super mop” in FIG. 9). In 1403, the promotion management module 204 also increases the rating assigned to the specific promotion. In 1404, the promotion management module 204 determines that a product category associated with a specific promotion (e.g., “Home and garden” in FIG. 12) corresponds to a product category included in the product information in the real-time user context information (e.g., “Home and garden” in FIG. 9). In 1404, the promotion management module 204 also increases the rating assigned to the specific promotion. In 1405, the promotion management module 204 determines that a consumer segment associated with a specific promotion (e.g., “18-80 Male, female”in FIG. 12) corresponds to a user segment included in the user profile information in the real-time user context information (e.g., “18-35 Male” in FIG. 9). In 1405, the promotion management module 204 increases the rating assigned to the specific promotion. In 1406, the promotion management module 204 determines that a loyalty status associated with a specific promotion (e.g., “Loyalty Card Required” in FIG. 12) corresponds to a user loyalty status included in the user profile information in the real-time user context information (e.g., “Loyalty Card #123456” in FIG. 9). In 1406, the promotion management module 204 also increases the rating assigned to the specific promotion. Conversely, if the promotion management module 204 determines that any of the conditions in 1401-1406 are not satisfied, then the promotion management module 204 may decrease the rating assigned to the specific promotion (rather than increase the rating). The ordering of 1401-1406 in method 1400 may be modified, and one or more of 1401-1406 may be omitted in the method 1400.

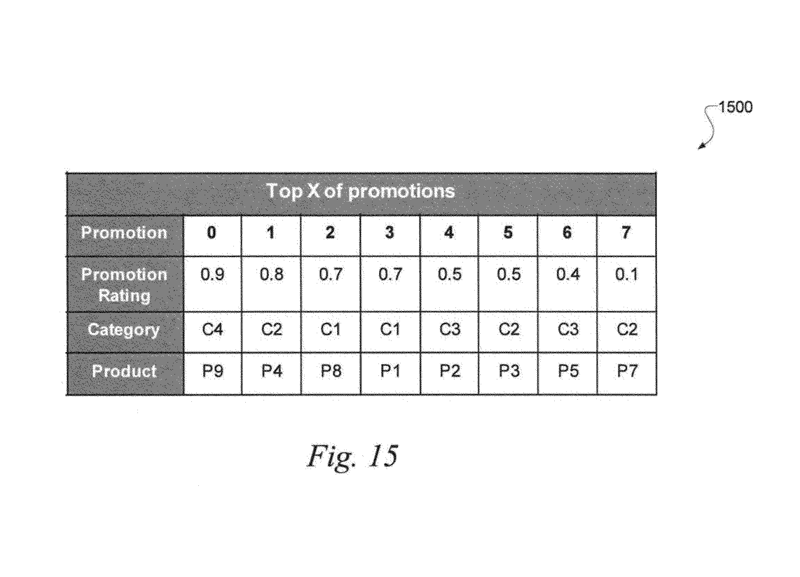

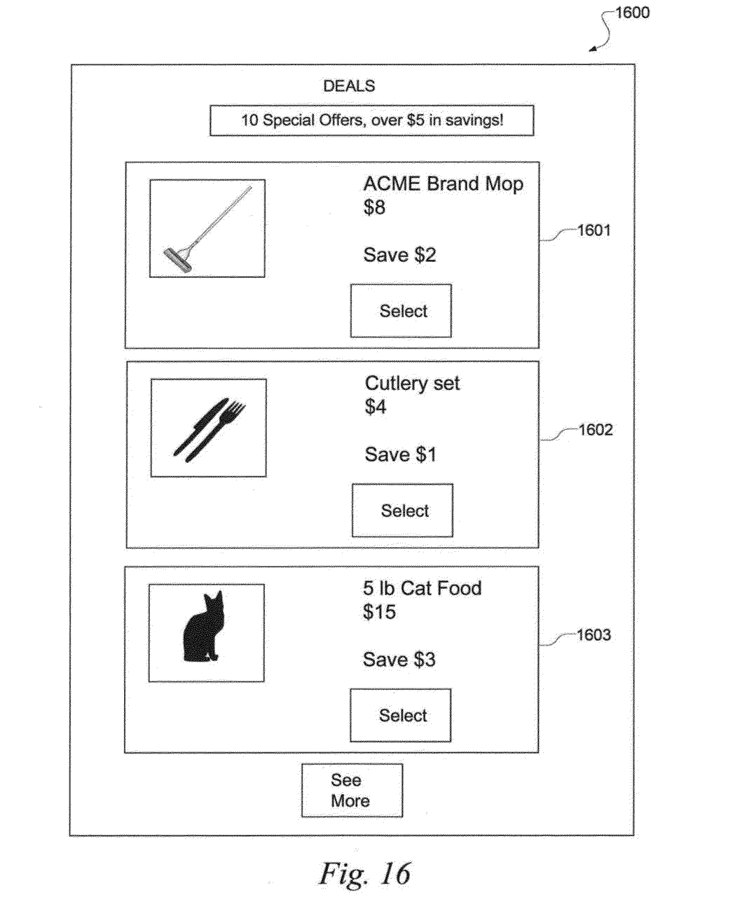

Referring back to FIG. 10, after the promotion management module 204 assigns a rating to each of various promotions, in 1003 the promotion management module 204 generates a list of the promotions. The list of promotions is ordered based on the ratings assigned to each promotion, such that the promotion with the highest rating is at the top of the list, the promotion with the second highest rating is the second from the top of the list, and so forth. The list displayed by the promotion management module 204 may simply include a subset of the promotions, such as the top 10 or 20 promotions (based on the ratings assigned to each of the promotions). For example, FIG. 15 illustrates an example of information 1500 regarding the top 10 promotions (i.e. the 10 promotions with the highest ratings, in order of rating). As seen in FIG. 15, promotion 0 has a promotion rating of 0.9, is associated with product category C4, and is associated with product P9, while promotion 1 has a promotion rating of 0.8, is associated with product category C2,and is associated with product P4, etc. All or a portion of the list generated by the promotion management module 204 may be displayed on user's client device (e.g., machines 110 and 112 illustrated in FIG. 1). For example, FIG. 16 illustrates an example of a list of promotions 1601-1603 displayed on a user interface 1600 of a client device for a user to view. The promotion 1601 in FIG. 16 may correspond to the promotion 0 in FIG. 15, the promotion 1602 in FIG. 16 may correspond to the promotion 1 in FIG. 15, and so forth. In other words, the promotion 1601 displayed at the top of the list has the highest rating, indicating that the user may have the greatest interest in promotion 1601, while the promotion 1602 displayed second in the list has the second highest rating, and so forth.

Thus, according to various exemplary embodiments, a precision-retailing system may provide a 1-1 relationship between a consumer and a retailer, based on the user's real-time interests at the actual point of decision or point of purchase (e.g., when the user is in a retail store and looking to purchase products). Thus, the precision-retailing system provides the right recommendation (promotions, suggestions, substitutions), to the right customer (personalized contextual offers), at the right time (in real time, according to the user retail context across various interaction channels).

According to various exemplary embodiments, the precision retailing system 200 may modify the ratings assigned to the promotions, or the ordering of the displayed list of promotions, or the subset of promotions included in the list of promotions, based on various factors such as a purchase history of the user, user preferences, and user feedback.

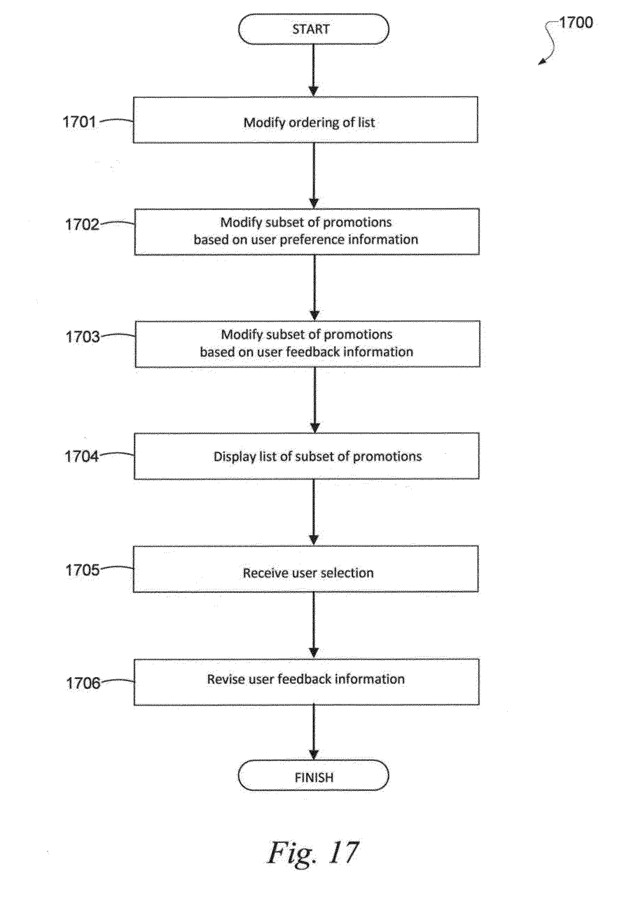

For example, FIG. 17 is a flowchart illustrating an example method 1700, according to various embodiments. The method 1700 may be performed at least in part by, for example, the precision retailing system 200 illustrated in FIG. 2 (or a precision retailing apparatus having similar modules, such as client machines 110 and 112 or application server 112 illustrated in FIG. 1). The method 1700 may be performed after operations 1001-1003 in the method 1000 of FIG. 10 (and/or possibly before the list is displayed to the user in 1003 of method 1000).

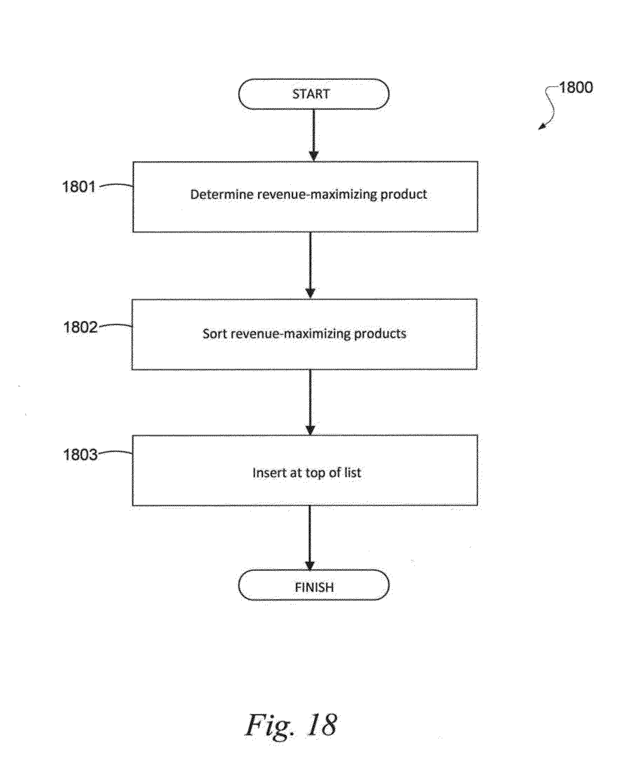

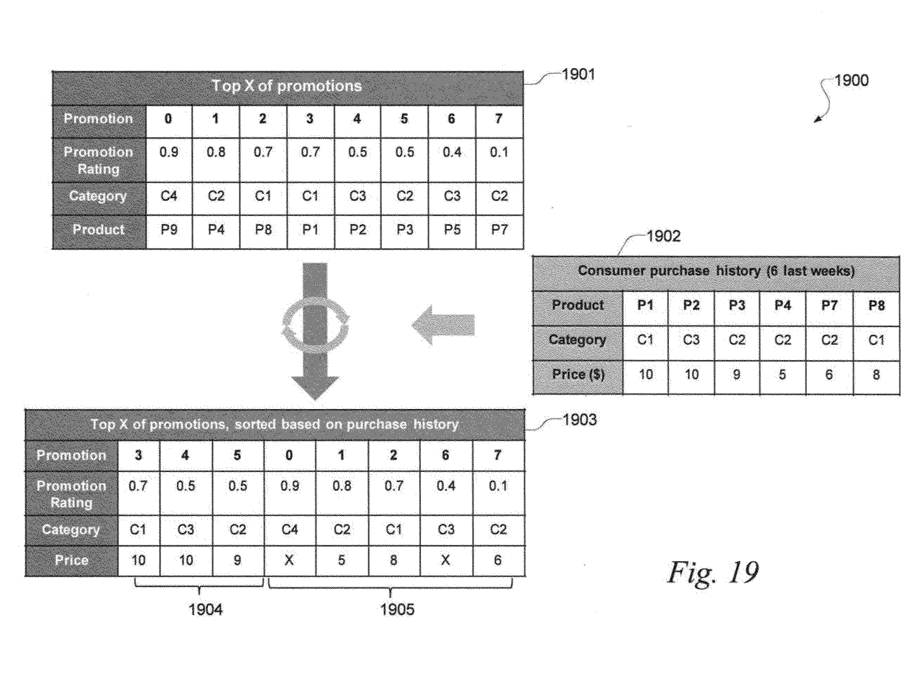

In 1701, the promotion management module 204 modifies the ordering of the list, possibly based on user purchase history information in the real-time user-context information 900. For example, the real-time user context information 900 illustrated in FIG. 9 may include user profile context information 903 that includes a link to user purchase history information. An example of how the promotion management module 204 modifies the ordering of the list based on purchase history information is illustrated in FIG. 18 and FIG. 19.

FIG. 18 is a flowchart illustrating an example method 1800, according to various embodiments. The method 1800 may be performed at least in part by, for example, the precision retailing system 200 illustrated in FIG. 2 (or a precision retailing apparatus having similar modules, such as client machines 110 and 112 or application server 112 illustrated in FIG. 1).

In 1801, the promotion management module 204 analyzes all the products and product categories listed in the user's purchase history, and determines, for each specific product category listed in the user purchase history information, a revenue-maximizing product in the purchase history information that is associated with that product category. Such revenue-maximizing products may already be included in the current list of top promotions. For example, FIG. 19 illustrates a list 1901 of top 10 promotions, ordered based on the ratings assigned to the promotions. FIG. 19 also illustrates user purchase history information 1902 that indicates, for example, products that the user has purchased in the last 6 weeks (such us product P1 associated with product category C1 at a price of $10, and so forth). In 1801, for each of the product categories in the user purchase history information 1402 (i.e., product categories C1, C2 and C3 in FIG. 14), the promotion management module 204 determines the most expensive product (hereinafter, a “revenue-maximizing product”) in the user purchase history information associated with that product category, such as product P1 For category C1, product P3 for category C2, and product P2 for product category C3 in FIG. 19. The selected revenue-maximizing products may already be associated with promotions in the list 1901.

Thereafter, in 1802, the promotion management module 204 sorts the revenue-maximizing products, based on the ratings assigned to the promotions associated with revenue-maximizing products. For example, the promotion management module 204 may sort the revenue-maximizing products P1, P3 and P2 into the order P1, P2, P3, since as seen in list 1001 the product P1 is associated with the promotion 3 having the highest rating 0.7, product P2 is associated with the promotion 4 having the second highest rating 0.5, and product P3 is associated with the promotion 5 also having the second highest rating 0.5, Because both products P2 and P3 are associated with promotions 4 and 5 having the same rating, a tie-breaker may be the price of the products (i.e., product P2 costs more than product P3, and so is given a higher position in the sorting).

In 1803, the promotion management module 204 may change the order of the final list of promotions displayed to the user, by inserting promotions associated with the sorted revenue-maximizing products at a top portion of the list. For example, FIG. 19 illustrates a modified list 1903, where the promotions 3, 4 and 5 corresponding to the sorted revenue-maximizing products P1, P2, P3 have been inserted into the top of the list 1903 at portion 1904. The remaining promotions in the list may be resorted or reordered based on, for example, the ratings assigned to each of the remaining promotions (see portion 1905 of the list 1903).

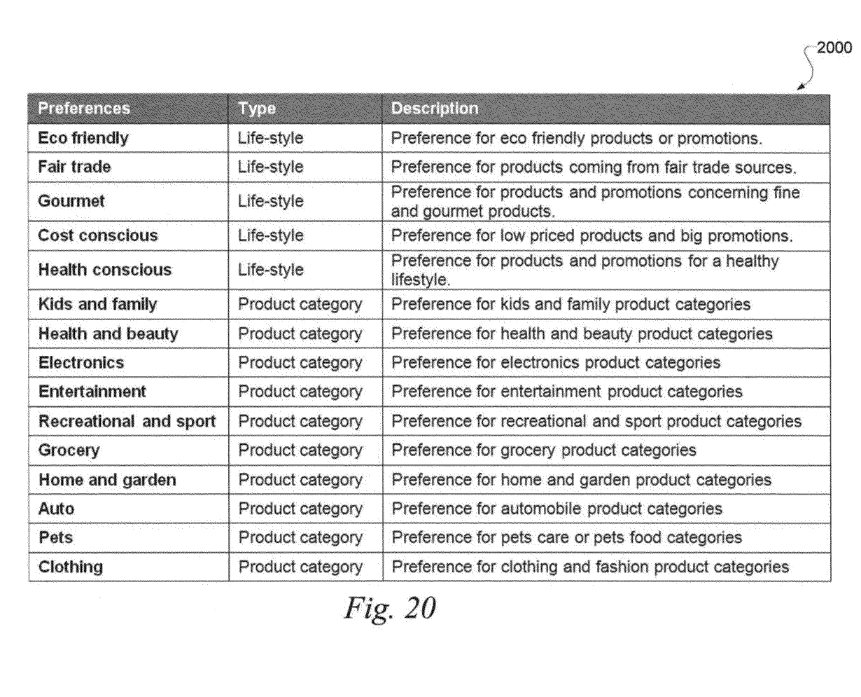

Returning back to FIG. 17, in 1702, the promotion management module 204 may modify the subset of the promotions included in the list displayed to the user, based on user preference information included in the real-time user context information. For example, the real-time user context information 900 illustrated in FIG. 9 may include user profile context information 903 that includes various known preferences of the user (e.g., the user may select these preferences from preference options displayed in a user interface of the user's client device), such as the positive user preference for an “eco-friendly lifestyle” or the negative user preference for “medical products” and “hygiene products” as seen in FIG. 9. Non-limiting examples of other preferences are included in the exemplary preference information 2000 of FIG. 20. Since each of the promotions in the list 1903 is associated with one or more products and/or product categories (e.g., see the promotion information of FIG. 12), and since the real-time user context information includes user preference information for the user (see, e.g., the user's personal preferences in FIG. 9), the system 200 may ensure that promotions corresponding the user's positive preferences are included in the subset of promotions in the list 1903, while promotions corresponding to the user's negative preferences are not included in the subset of promotions in the list 1903.

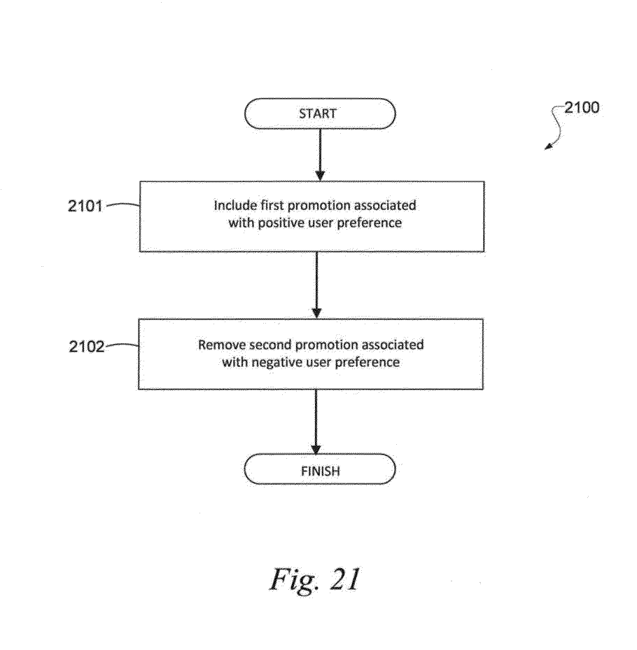

For example, FIG. 21 is a flowchart illustrating an example method 2100, according to various embodiments. The method 2100 may be performed at least in part by, for example, the precision retailing system 200 illustrated in FIG. 2 (or a precision retailing apparatus having similar modules, such as client machines 110 and 112 or application server 112 illustrated in FIG. 1). In 2101, the promotion management module 204 includes, in the subset of promotions displayed to a user, a first promotion that is associated with a positive user preference in the user preference information of the real-time user context information. In 2102, the promotion management module 204 removes, from the subset of promotions displayed to a user, a promotion that is associated with a negative user preference in the user preference information of the real-time user context information. The ordering of 1201-1202 in method 1200 may be modified, and each of 1201-1202 may be omitted in the method 1200.

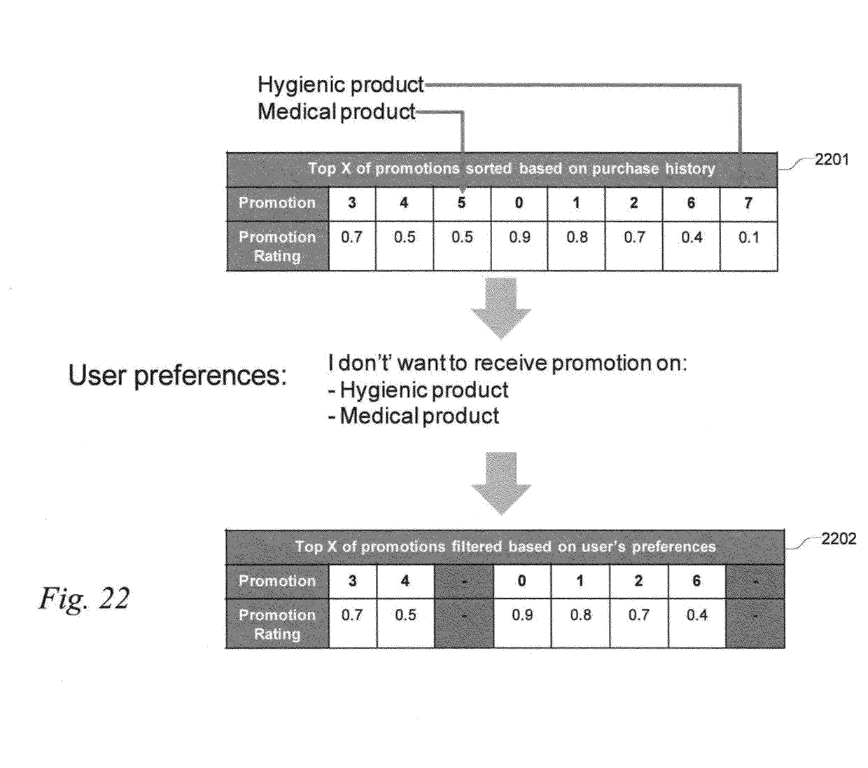

FIG. 22 illustrates the data 2201 corresponding to the list of promotions displayed to the user after the order of the list has been modified based on user purchase history information, as described above with reference to FIG. 19. Since the promotion management module 204 determines that the user preferences illustrated in FIG. 9 include a negative preference for medical and hygienic products, and since the promotion management module 204 determines that promotion 5 is associated with a medical product and promotion 7 is associated with a hygienic product, the promotion management module 204 may remove the promotions 5 and 7 from the list 2201 to generate a modified list 2202. Although not illustrated in FIG. 22, the list 2202 may be further modified to include other promotions to take the place of the removed promotions 5 and 7 (or the promotions 0, 1, 2 and 6 may move up one position, and two new promotions may take the bottom two positions in the list 2202, etc.).

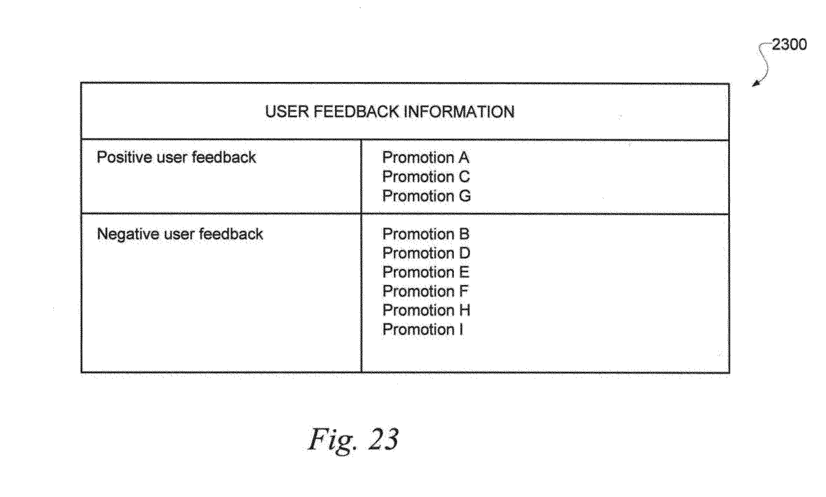

Returning back to FIG. 17, in 1703, the promotion management module 204 may modify the subset of the promotions included in the list displayed to the user, based on user feedback information included in the real-time user context information 900. For example, the real-time user contest information 900 illustrated in FIG. 9 may include user profile context information 903 that includes a link to user feedback information indicating the users previous acceptance or refusal/ignoring of promotions displayed in the past. FIG. 23 illustrates an example of user feedback information 2300, which indicates that the user has previously provided positive feedback for promotions A, C, and G (e.g., the user has clicked on these promotions, added these promotions to their shopping cart or shopping list, applied these promotions to a purchase, etc.), e.g. when the user selects the “SELECT” button for a promotion listed in the promotion list in FIG. 16 and which further indicates that the user has previously provided negative feedback for promotions B, D, E, F, H and I (e.g., the user has not clicked on these promotions, not added these promotions to their shopping cart or shopping list, not applied these promotions to a purchase, etc.). Based on this user feedback information, the system 200 may ensure that promotions for which the user has provided positive feedback are included in the subset of promotions in the list, while promotions for which the user has provided negative feedback are not included in the subset of promotions in the list.

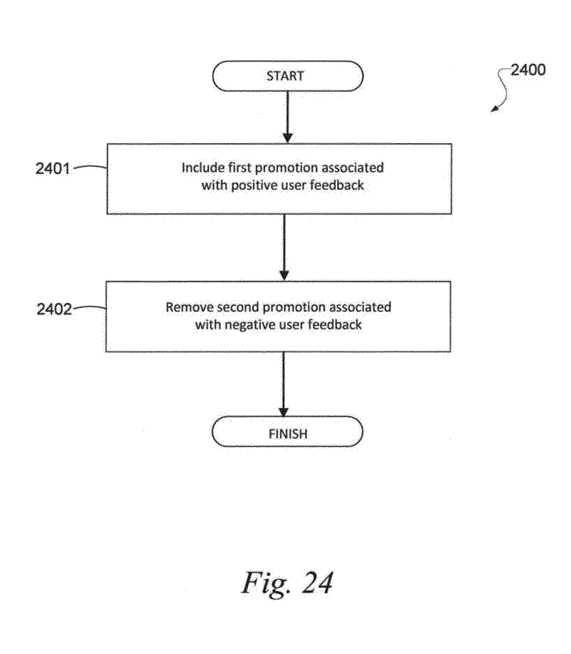

For example, FIG. 24 is a flowchart illustrating an example method 2400, according to various embodiments. The method 2400 may be performed at least in part by, for example, the precision retailing system 200 illustrated in FIG. 2 (or a precision retailing apparatus having similar modules, such as client machines 110 and 112 or application server 112 illustrated in FIG. 1). In 2401, the promotion management module 204 includes, in the subset of promotions displayed to a user, a first promotion that is associated with a positive feedback in the user feedback information of the real-time user context information 900. In 2402, the promotion management module 204 removes, from the subset of promotions displayed to a user, a second promotion that is associated with a negative user feedback in the user feedback information of the real-time user context information 900. The ordering of 2401-2402 in method 2400 may be modified, and each of 2401-2402 may be omitted in the method 2400.

Returning back to FIG. 17, in 1704, the promotion management module 204 displays the list of the subset of promotions (which have been modified based on user purchase history information, user preference information and/or user feedback information) on a user interface of a client device (e.g., similar to the exemplary list 1100 illustrated in FIG. 11). In 1705, the promotion management module 204 receives a user selection of one of the displayed promotions (e.g., when the user clicks on “Select” button for one of the promotions in FIG. 16). In 1706, the promotion management module 204 generates and/or revises user feedback information included in the user profile information, to indicate in the user feedback information a positive feedback associated with the selected promote or a negative feedback associated with a non-selected promotion. For example, with reference to the user feedback information 2300 of FIG. 23, if the user selects a promotion J, the promotion J may be added to the user feedback information 2300 as a positive user feedback, whereas if the user does not select a promotion K, the promotion K may he added to the user feedback information 2300 as a negative user feedback.

According to various exemplary embodiments, the system 200 may determine one or more products or product categories that the user may be interested in, based on the current location of the user. For example, if the user is close to or inside a particular store that is known for selling particular products in particular products categories, then the system 200 may revise the real-time user context information to reflect this information. Similarly, if the user is actually standing near a particular aisle or section of a store that stocks particular products in particular product categories, then the system 200 may revise the real-time user context information to reflect this information.

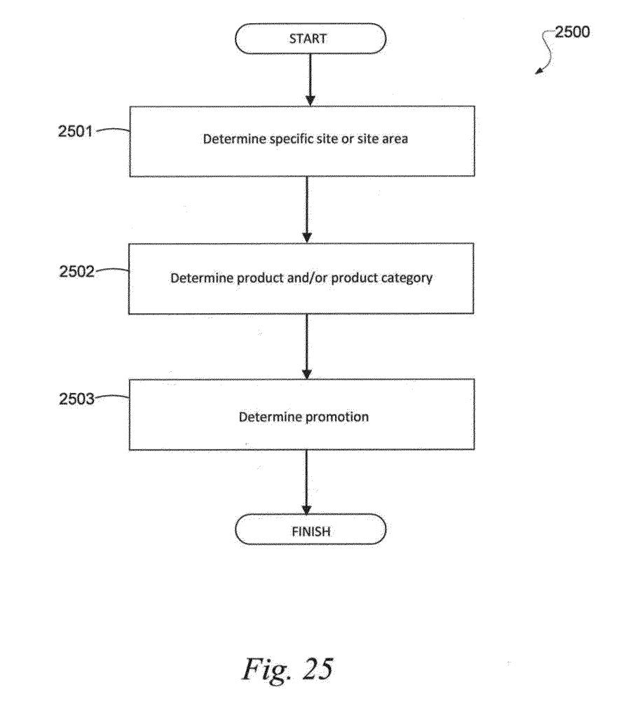

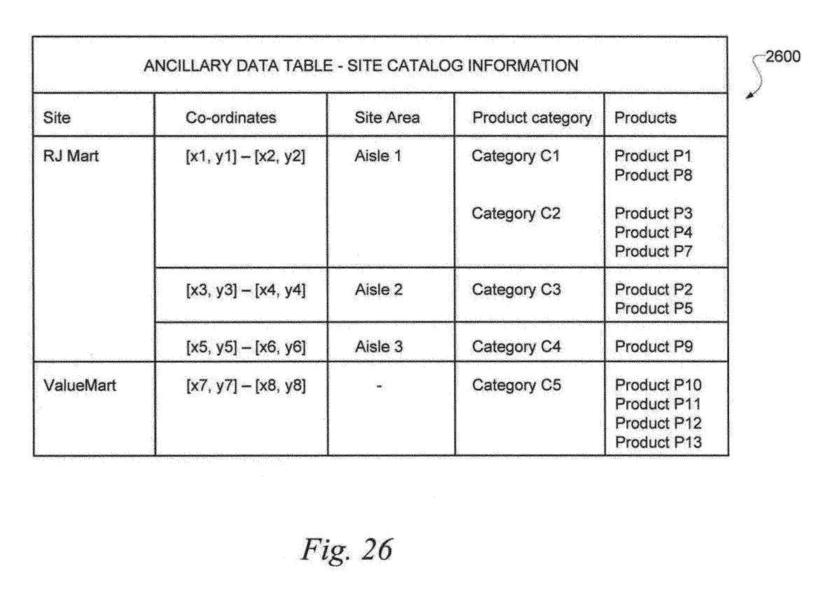

For example, FIG. 25 is a flowchart illustrating an example method 2500, according to various embodiments. The method 2500 may be performed at least in part by, for example, the precision retailing system 200 illustrated in FIG. 2 (or a precision retailing apparatus having similar modules, such as client machines 110 and 112 or application server 112 illustrated in FIG. 1). In 2501, the context calculation module 202 determines that the current user location information is associated with any one of a specific site (e.g., retail store) or site area (e.g., aisle in retail store). The context calculation module 202 may refer to site catalog information, such as site catalog information 2600 illustrated in FIG. 26. For example, the context calculation module 202 may process the GPS co-ordinates in the current user location information (e.g., “37:47:36 N. 122:33:17 W.” in FIG. 9) and compare it with the known co-ordinates of various sites or site areas, based on the site catalog information 2600, to determine that, for example, the co-ordinates fit in the range [x7,y7]-[x8,y8] corresponding to Aisle 3 of the RJ Mart. In 2502, the context calculation module 202 determines a product/product category associated with the specific site or site area. For example, the context calculation module 202 may refer to the site catalog information 2600 to determine that product P9 and product category C4 are associated with Aisle 3 in the RJ Mart.

In 2503, the promotion management module 204 determines that a product/product category associated with a specific promotion corresponds to the product/product category determined is 2502 that is associated with the site or site area determined is 2501. For example, the promotion management module 204 may determine that a product P9/product category C4 associated with a promotion 0(see FIG. 15) in fact corresponds to product P9/product category C4 that is associated with Aisle 3 in the RJ Mart (see FIG. 26). Also in 2503, the promotion management module 204 may increase the rating assigned to the specific promotion so that the promotion appears higher in the list of promotions displayed to the user. Thus, for example, if the promotion management module 204 determines that the user is currently at GPS co-ordinates corresponding to a frozen food aisle of the RJ Marts, then the promotion management module 204 may ensure that promotions related to frozen food are included in the list of promotions displayed to the user.

### Ancillary Data Updates

As described above in connection with FIG. 5, the ancillary data 52 populated into the ancillary data tables 502 need not be updated in real-time. The context calculation module 202 may be configured to access each type of ancillary data for population into the ancillary data tables at different periodic time intervals. More specifically, according to various exemplary embodiments, the precision retailing system 200 permits the user of the system 200 (e.g., such as business operator, marketing analyst, or retailer) to adjust the different periodic time intervals at which each type of ancillary data 52 is updated and populated into the ancillary data tables 502.

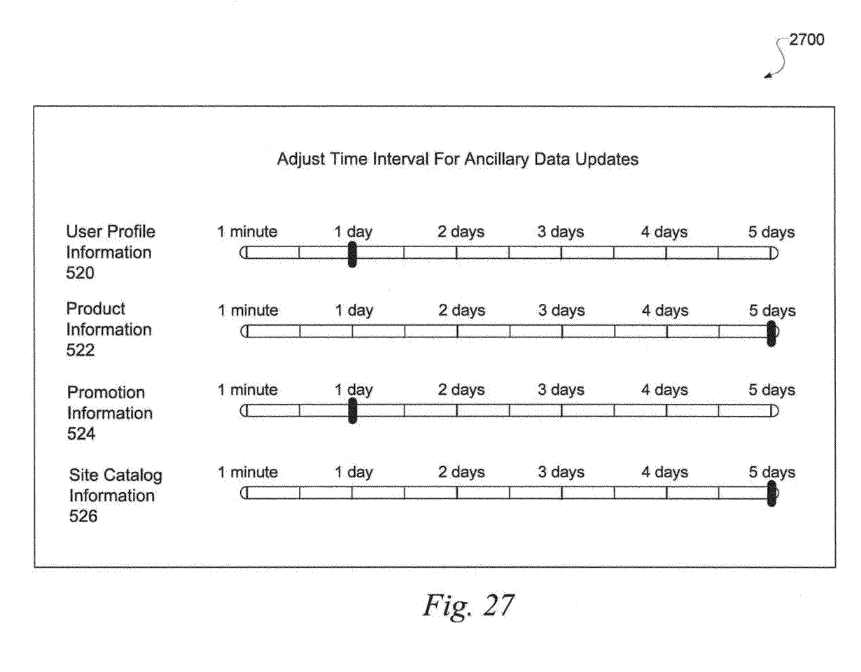

For example, FIG. 27 illustrates an example of a user interface screen 2700 displayed by the context calculation module 202. The user interface screen 2700 displays a selector for each type of ancillary data 52, including a selector for the user profile information 520, a selector for the product information 522, a selector for the promotion information 524, and a selector for the site catalog information 526. Each selector permits the user (e.g., retailer) to adjust the periodic time interval at which the corresponding ancillary data is updated and populated into the ancillary data tables 502. For example, as illustrated in FIG. 27, the user profile information 520 and promotion information 524 are updated once a day, whereas the product information 522 and site catalog information 526 may be updated once a week.

The retailer may wish to adjust the periodic time intervals based on an expectation that some types of ancillary data may change more often than others. Alternatively, the retailer may wish to adjust the periodic time intervals based on the type of information that is deemed most important for a given task, such as generating reports (which is performed by the reporting module 208 as described in more detail below). That is, the ancillary data 51 can be updated based on the preference of the retailer or the reporting demand/importance. For instance, the consumer profile information 520 & promotion information 524 ancillary data can be updated at separate or different intervals to the product information. For example, if for instance the emphasis is on reporting the consumer's performance (KPI or Key Performance Indicator), then the consumer profile information 520 & promotion information 524 ancillary data can be treated with a higher importance and hence be updated in near to real time as possible, whereas updating product information 522 could be done at longer intervals. The ability to adjust these update interval helps maintain the reporting importance for the retailer while also reducing TCO (Total Cost of Ownership)—i.e. only getting the data that is needed in a timely fashion.

### Suggestions Management

As described above, the promotion management module 204 may utilize the real-time user context information 900 illustrated in FIG. 9 to assign ratings to each of a number of promotions, and then display the promotions on a mobile device of the user based on the assigned ratings.

According to another exemplary embodiment, the promotion management module 204 may utilize the real-time user context information 900 to determine an optimized list of suggested products for the user, based on the current mobile interaction event described by the real-time user context information. For example, if the mobile interaction event corresponds to the user viewing the product related web page 400 illustrated in FIG. 4 (i.e., a webpage about the product Acme brand super mop), then the real-time user context information 900 describing this mobile interaction event may be utilized to provide the user with an optimized list of suggestions of other products that the user might be interested in, notwithstanding whether these of the products are associated with special promotions, coupons, discounts, etc.

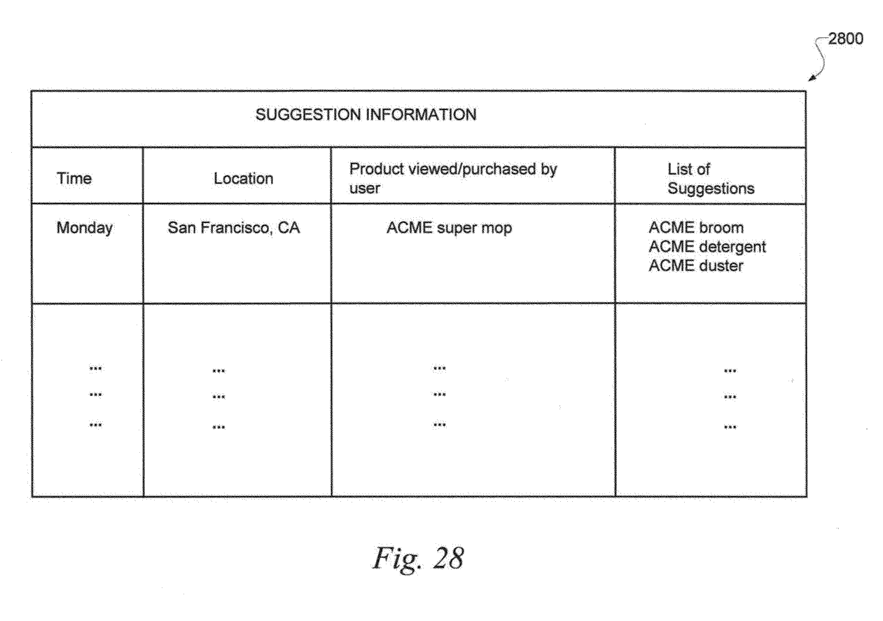

For example, the promotion management module 204 may access suggestion information indicating a list of suggested products for a particular situation. An example of suggestion information 2800 is illustrated in FIG. 28. Each entry in the suggestion information 2800 indicates situational parameters of a particular situation. The particular situation maybe, for example, that a user in a particular location (site, street, suburb, city, state, country, etc.) and at a particular time (particular time of day, day of week, mouth of year, etc.) is currently performing a mobile interaction event with a particular product (e.g., viewing a product on their mobile device, adding the product to a shopping list, purchasing a product via their mobile device, etc). Of course, the suggestion information may include other situational parameters in addition to time, location, and product viewed/purchased. Examples of other situational parameters may include an identity of the user, a user segment of the user, a loyalty status of the user, preferences of the user, user purchase history information of the user, user feedback information of the user (e.g., what previous promotions or suggestions as the user selected), and so forth. The suggestion information 2800 may also include a subset the aforementioned situational parameters.

For a given situation (defined by the aforementioned situational parameters in the suggestion, information), the suggestion information indicates a list of suggested products that the user may be interested in. For example, the suggestion information 2000 of FIG. 28 indicates that if the user is in San Francisco and the user views or purchases the product “Acme super mop” a Monday, then the user may be interested in the Acme broom, Acme detergent, and Acme duster products.

The promotion management module 204 is configured to compare the real-time user context information 900 illustrated in FIG. 9 with the suggestion information 2800 illustrated in FIG. 28, to determine a list of suggestions applicable to the mobile interaction event described is the real-time user context information 900. Thereafter, the promotion management module 204 may display a message on mobile device of the user, asking if the user is interested in one of these products. The selections of the user and may be fed back to user feedback information (which may be one of the situational parameters of the suggestion information 2800, as described above).

Moreover, the promotion management module 204 may utilize the site catalog information 2600 in FIG. 26 to optimize the list of suggestions displayed for the user. For example, if the real-time user context information 900 indicates the user is at a particular location, the site catalog information 2600 may be utilized to determine the site where the user is and the various products at that site. The list of suggestions may be optimized based on the products available at the site with the user is located.

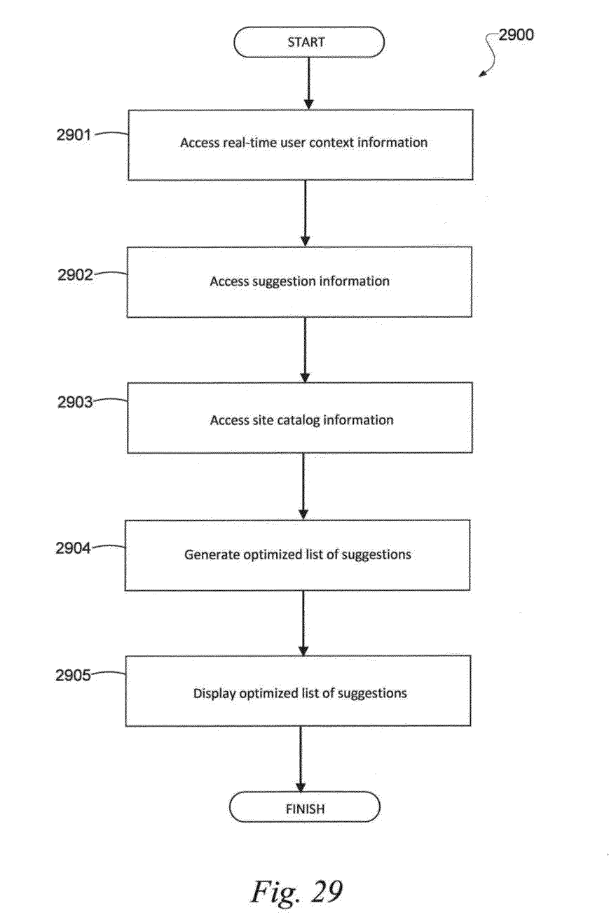

FIG. 29 is a flowchart illustrating an example method 2900, according to various embodiments. The method 2900 may be performed at least in part by, for example, the 200 illustrated in FIG. 2 (or an apparatus having similar modules, such as client machines 110 and 112 or application server 112 illustrated in FIG. 1). In 2901, the promotion management module 204 accesses real-time user context information (e.g., see FIG. 9). In 2902, the promotion management module 204 access suggestion information (e.g., see FIG. 28). In 2903, the promotion management module 204 accesses site catalog information (e.g., see FIG. 26). In 2904, the promotion, management module 204 generates an optimized list of suggestions for a user. In 2905, the promotion management module 204 displays the optimized list of suggestions on a mobile device of the user. Various elements of method 2900 may be omitted or rearranged, as necessary.

### Reporting

According to various exemplary embodiments, the precision retailing system 200 is further configured to utilize all the different types of interaction data 51 that are captured per consumer, for a number of consumers, coupled with all the different types of ancillary data 52, to analyse the behaviour of the consumer/promotion/suggestion from a retailer's perspective. That is, the reporting module 208 is configured to perform statistical analysis of both the real-time interaction data 51 stored in the interaction data table 501 and the ancillary data 52 stored in the ancillary data tables 502, to generate analytics data for reporting. An example of such analytics data may be data describing which promotions perform best in which locations, what suggested products worked best over a given period. Whom are the recurring consumers or best shoppers in what locations, and so forth.

In particular, the reporting module 208 may display a precision retailing real-time dashboard that is a user interlace that permits a user of the precision retailing system 200 (e.g., business administrator, business user, retailer, etc.) to specify parameters for a report. Based on the user specified parameters, the reporting module 208 analyzes all the interaction data 51 for multiple users in the interaction data table 51, and the ancillary data 52 in the ancillary data tables 502, and generates reports. The generated reports may be displayed in the precision retailing real-time dashboard.

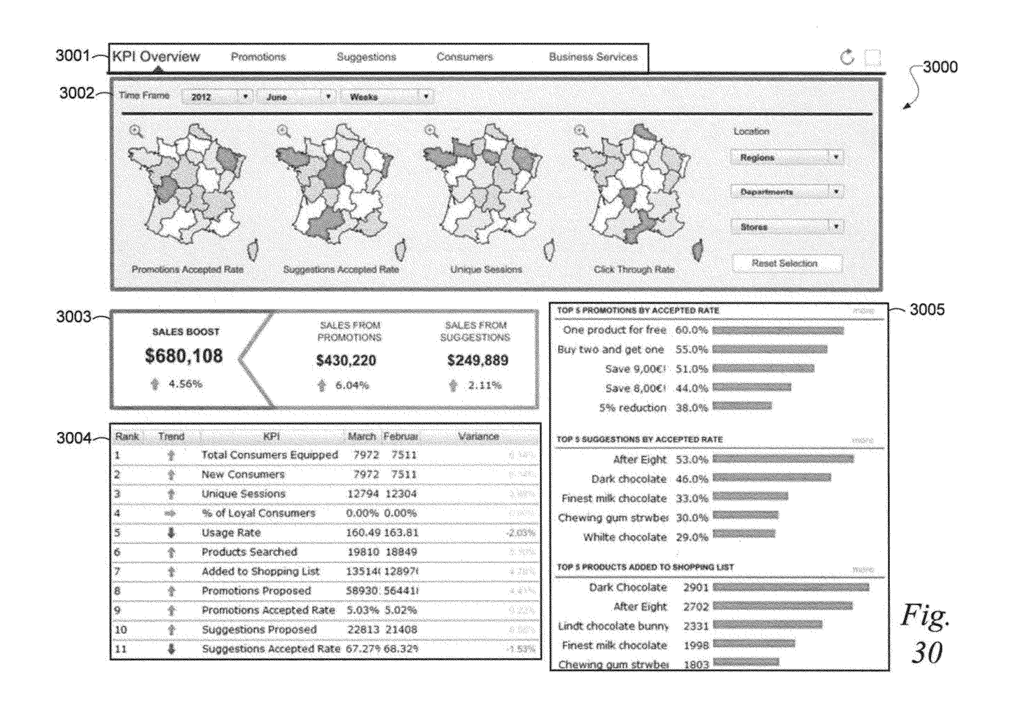

FIG. 30 illustrates an exemplary portion 3000 of the real-time dashboard. As seen in FIG. 30, the exemplary screen 3000 includes a main menu 3001, and multiple display areas including a heat map 3002, a big sales figure box 3003, a key performance indicator (KPI) table 3004, and a Top KPI box 3005. FIG. 30 illustrates an exemplary “KPI Overview” dashboard included in the display areas 3002-3005 when the “KPI Overview” button is selected in the main menu 3001. As described in more detail below, the dashboard displayed in the display areas 3002-3005 changes depending on the reporting parameter buttons selected in the main menu 3001 (e.g., a “Promotions” dashboard is displayed after user selection of the “Promotions” button, “Suggestions” dashboard is displayed after user selection of the “Suggestions” button, “Consumers” dashboard is displayed after user selection of the “Consumers” button, and “Business Services” dashboard is displayed after user selection of the “Business Services” button).

When business users select the “KPI Overview” button in the main menu 3001, business users can have an overall view of the overall marketing activities, to see how they are performing. The dashboard includes KPIs to monitor trends in customer behavior, promotions & suggestion performance, as well as their impact on the sales revenue. When business users select the “Promotion” button its the main menu 3001, Business Users can have a detailed view of the promotion performances per type, segment, location and interests for both loyal and anonymous customers. When business users select the “Suggestion” button in the main menu 3001, Business Users can have a detailed view of the product suggestions (Down Sales, Up Sales and Cross Sales) per type, segment, location and interest for both loyal and anonymous customers. Selection of the “Customer” button in the main menu 3001 enables a detailed understanding on the customer adoption, usage and behaviors per type, segment, location and interest for both loyal and anonymous customers. When business users select the “Business Services” button in the main menu 3001, Business Users can have a detailed view on product usage and customer patterns, for example, product search, scan or products added to the shopping list. In this dashboard the product performance is emphasized.

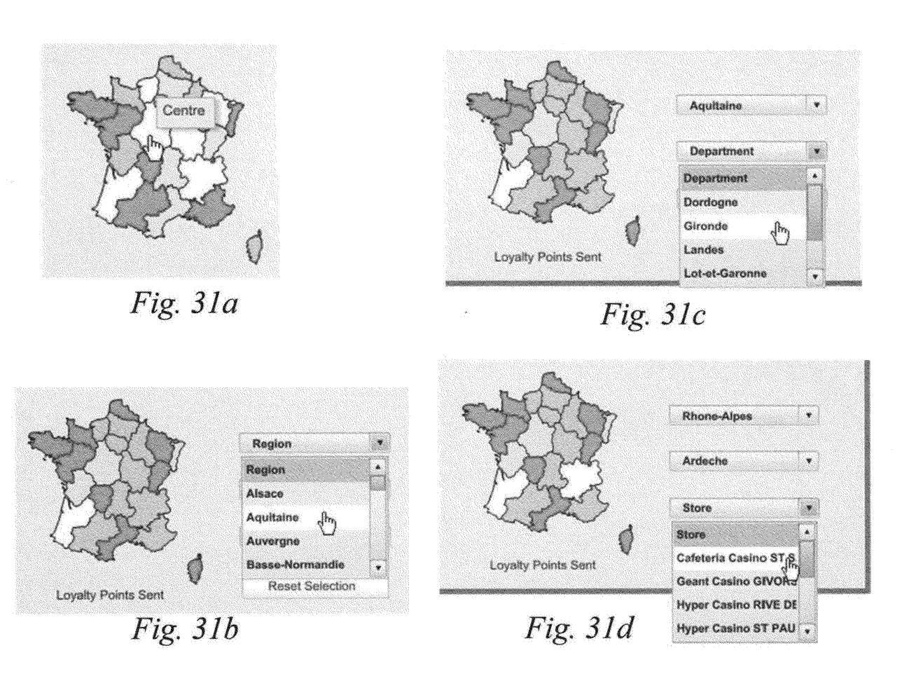

In heat map area 3002, the user can select various additional reporting parameters. The current month and year are already selected as drill down options. At any stage the Business User can alter the week, month and year to choose different time frames by which they wish to view the data. Moreover, the heat map area 3002 provides the user with the option to filter all results to a particular region that they may be interested in, by clicking on the map as illustrated in FIG. 31a. Once selected, the graphs and tables within the current view refresh to reflect the option chosen. Instead of selecting the region on the heat maps, it is also possible to choose them from the drill down menu “Region” on the right hand side of the heat maps, as illustrated in more detail in FIG. 31b. After a Business User has chosen a region, they then have the option to drill down further into departments (similar to counties or sub divisions) in that region, using the drill down menu on the right hand side of the heat maps, as illustrated in more detail in FIG. 31c. After a Business User has chosen a region and department, they then have the option to drill down further into stores in that region, using the drill down menu on the right hand side of the heat maps, as illustrated in more detail in FIG. 31d.

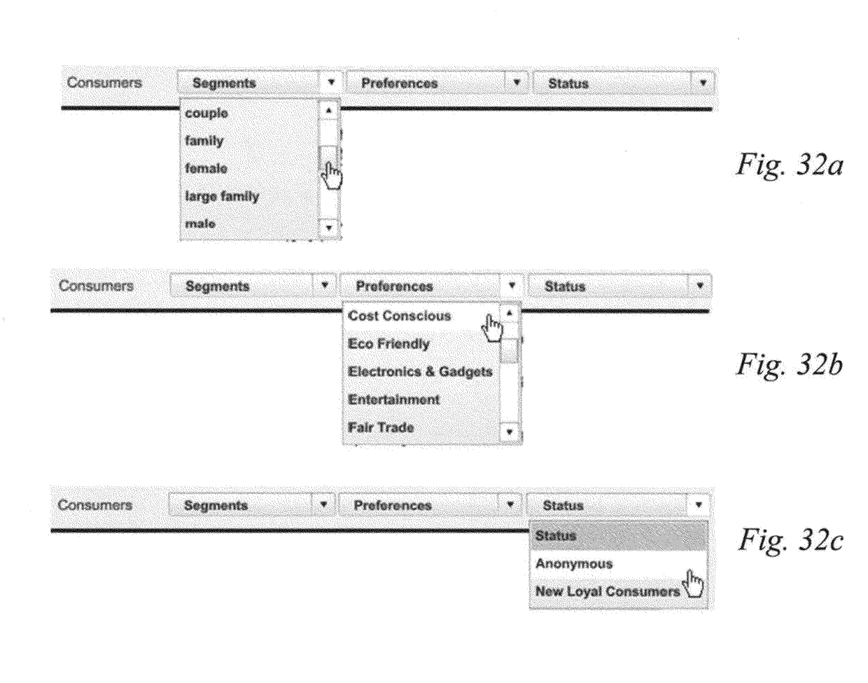

If one of the four dashboards Promotion, Suggestions, Consumers and Business Services is selected in the main menu area 3001, the heat map area 3002 may also permit the Business User the option to drill down further by selecting a consumer segment (as illustrated in FIG. 32a), consumer Preferences (as illustrated in FIG. 32b), and consumer Status (as illustrated in FIG. 32c).

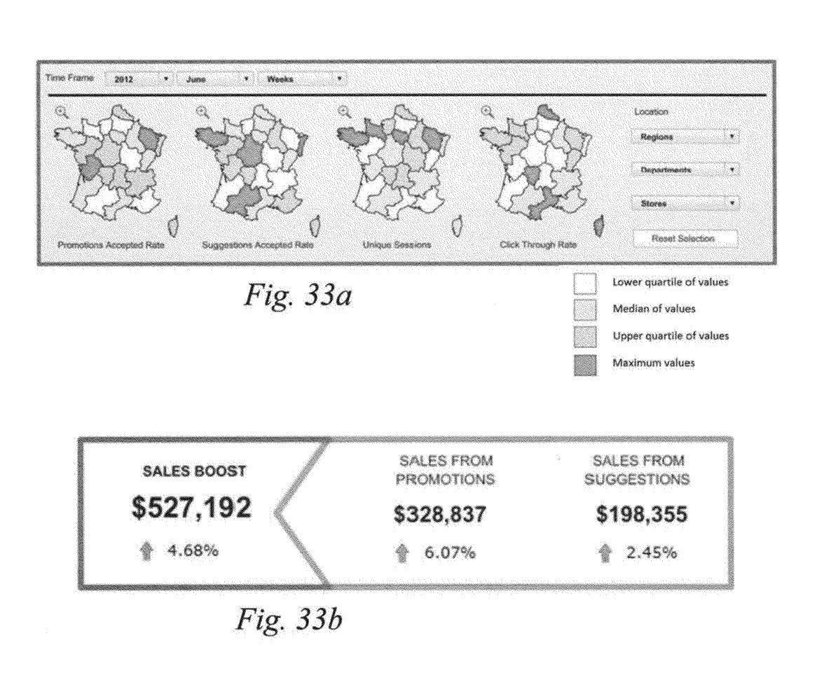

Inside each dashboard the there are four heat maps in the heat map area 3002. Each of them represents the percentage of certain characteristics in each region of the country. The characteristics depend on the selected dashboard. As illustrated in FIG. 33a, the regions are coloured in four different shades of blue. The darker the shade, the higher is the represented value in the region

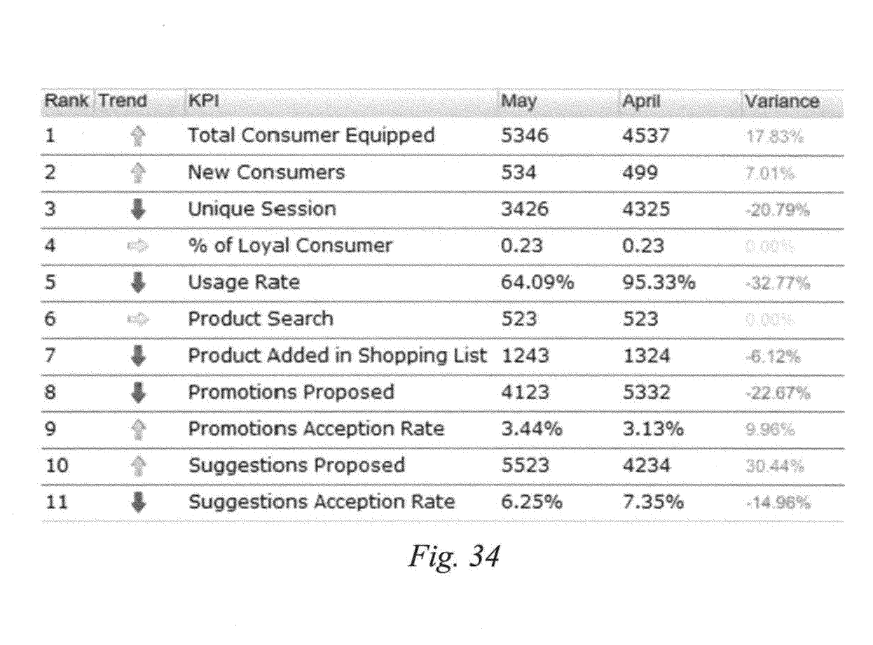

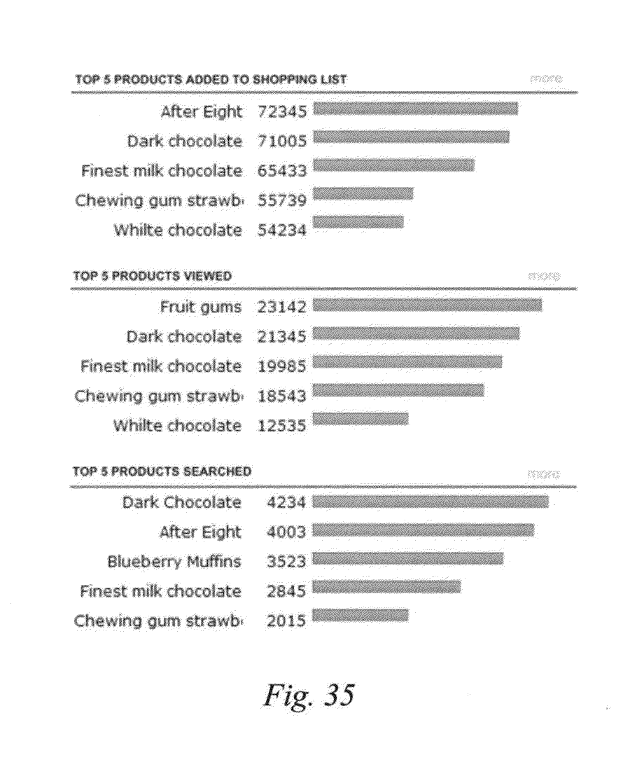

KPI Overview Dashboard: if the user selects “KPI Overview” button in main menu 3001, the user is presented with the “KPI Overview” dashboard. The heat maps 3002 in this dashboard give an overview on: Promotion Acceptation Rate; Suggestion Acceptation Rate; Unique Session; and Click through Rate (see FIG. 33a). The drill down options available to the right of the heat maps 3002 are by Year, Month, Week, Region, Department and Store (see FIG. 33a). When the Business User selects a particular object (Region, Department or by Store) on the map then the associated reports & graphics present the data associated with this object. The big sales figures box 3003 (see also FIG. 33b) accumulates the overall: Sales from promotions=Total value of the products added in the shopping list after the consumer has received a promotion; Sales from suggestions=Total value of the products added in the shopping list after the consumer has received a suggestion; and Sales Boost=Total value of the products added in the shopping list following a promotion or suggestion. The table 3004 shows the trends for the most important KPIs. There the figures from the selected month (or week) and previous month (or week) according to the selection are compared. The columns of the table 3004 (see also FIG. 34) include: rank (Identification number of each KPI); trend (The arrow symbol shows the direction of the trend at one glance—Green arrow for a positive trend, Yellow arrow for no changes, Red arrow for a negative trend); KPI (Short description of the measured KPI); Month 1 (Includes the figures of the selected month or week); Month 2 (Includes the figures of the previous month or week (according to the selection); and variance (Shows the extent of the trend in per cent). Box 3005 (see also FIG. 35) illustrates: Top 5 Products Added to Shopping List; Top 5 Products Viewed; Top 5 Products Searched.

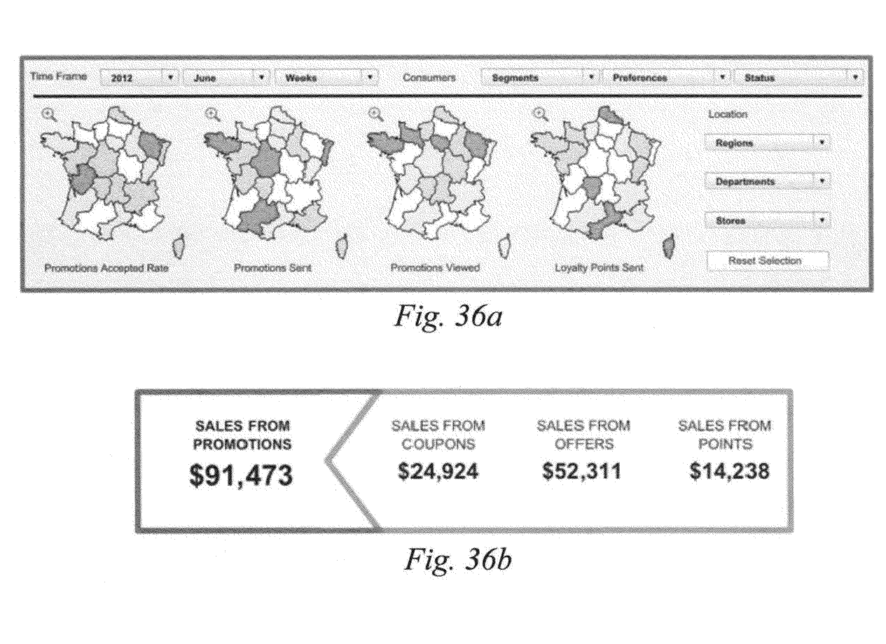

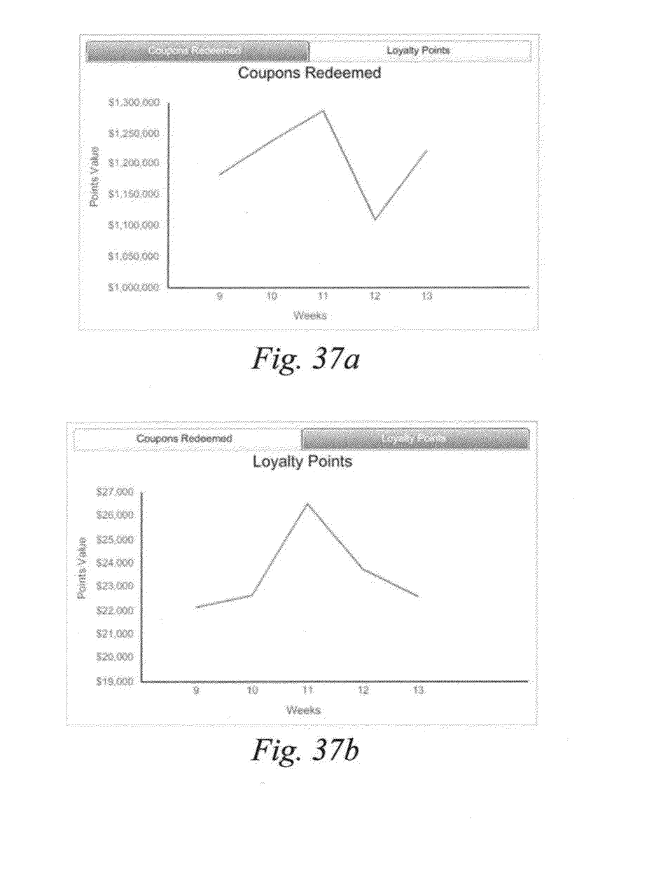

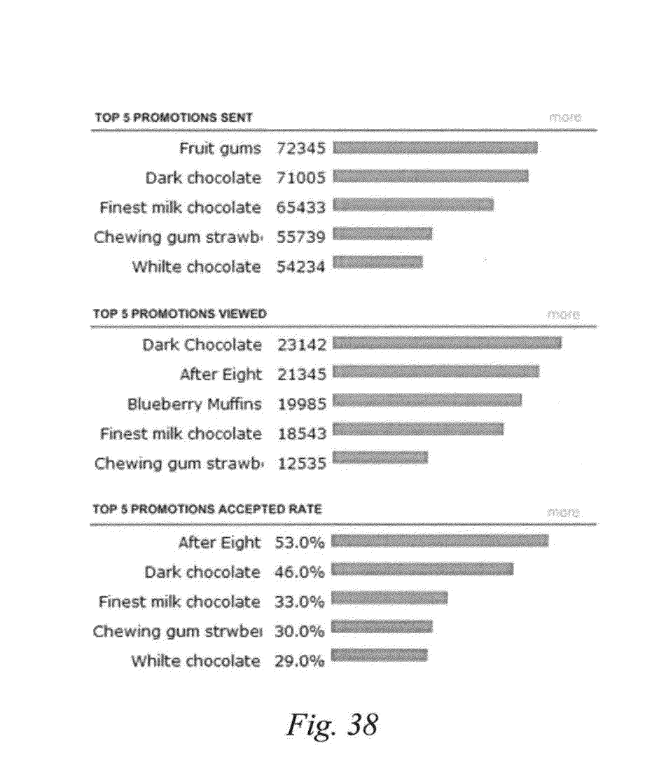

Promotions Dashboard: if the user selects “Promotions” button in main menu 3001, the user is presented with the “Promotions” dashboard. The heat maps in this dashboard give an overview on: Promotion Acceptation Rate; Promotion Sent; Promotion Viewed; Loyalty Points Sent (see FIG. 36a). As seen in FIG. 36a, the drill down options available here (and in the “suggestions”, “consumers” and “business services” dashboards described below) are by Year, Month, Week, Region, Department and Store. When the Business User selects a particular option (Region, Department or by Store) on the map then the associated reports & graphics present the data associated with this selection. Furthermore the Business User has the option to drill down by different Segments (“Single” or “Family”) and/or Preferences (e.g. “Animals” or “Cars”) and/of Status (e.g. “Anonymous” or “Loyal Consumer”), as illustrated in FIGS. 32A-32C. As illustrated in FIG. 36b, the big sales figures box accumulates the overall: Sales from Coupons (Total value of the products added in the shopping list after the consumer has received a coupon); Sales from Offers (Total value of the products added in the shopping list after the consumer has received an offer (excluding coupon and points)); Sales from Points (Total value of the products added in the shopping list after the consumer has received loyalty points); Sales from Promotions (Total value of the products added in the shopping list after the consumer has received a promotion of any type). As illustrated in FIG. 37a, the promotions dashboard may also display a coupons redeemed chart that represents the value of coupons redeemed for each week during the selected month. As illustrated in FIG. 37b, the promotions dashboard may also display a loyalty points chart that represents the value of all loyalty points redeemed for each week during the selected mouth. As illustrated in FIG. 38, the top rank box may display: Top 5 Promotions Sent; Top 5 Promotions Viewed; Top 5 Promotions Accepted Rate.

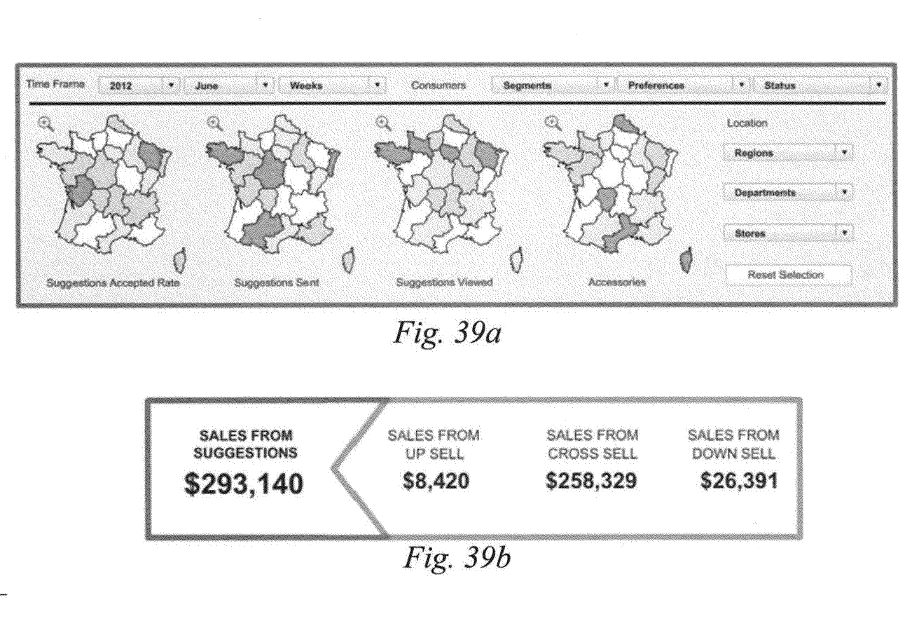

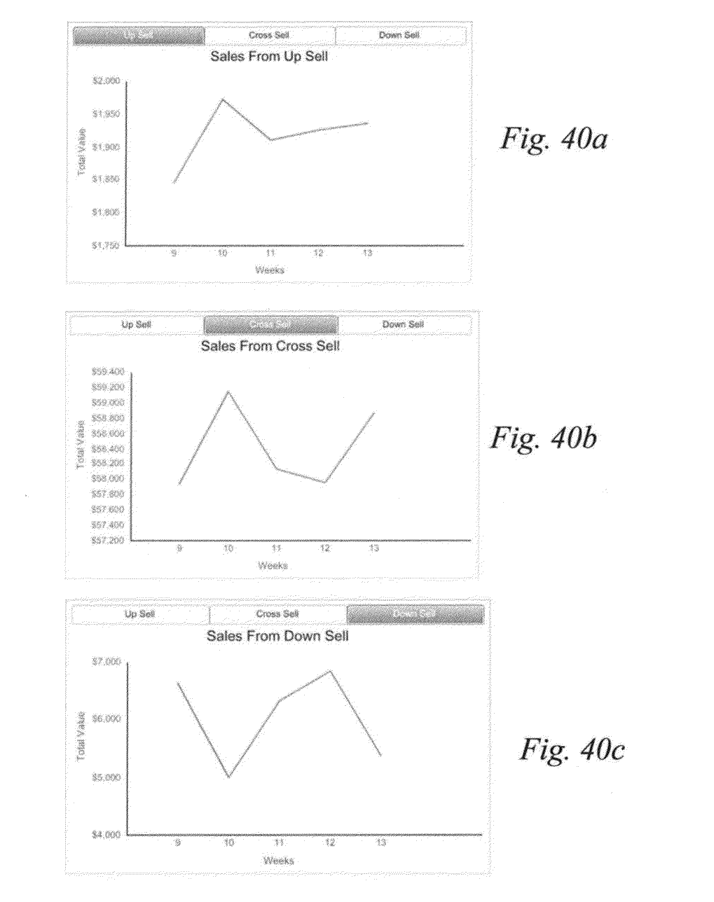

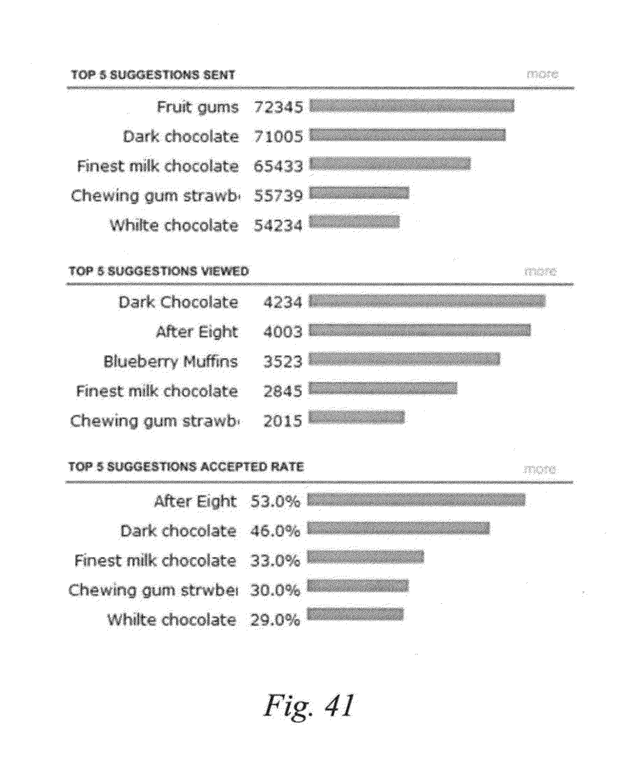

Suggestions Dashboard: if the user selects “Suggestions” button in main menu 3001, the user is presented with the “Suggestions” dashboard. The heat maps in this dashboard give an overview on: Suggestion Acceptation Rate; Suggestion Sent; Suggestion Viewed; Accessories (see FIG. 39a). As illustrated in FIG. 39b, the big sales figures box accumulates the overall: Sales from Up Sell (Total value of the products added in the shopping list alter the consumer has received a Up Sell, suggestion); Sales from Cross Sell (Total value of the products added in the shopping list after the consumer has received a Cross Sell suggestion); Sales from Down Sell (Total value of the products added in the shopping list after the consumer has received a Down Sell suggestion); Sales from Suggestions (Total value of the products added in the shopping list after the consumer has received a suggestion of any type). As illustrated in FIG. 40a, the suggestions dashboard may also display an Up Sell chart that represents the value of all Up Sell deals for each week during the selected month. As illustrated in FIG. 40b, the suggestions dashboard may also display a Cross Sell chart that represents the value of all Cross Sell deals for each week during the selected month. As illustrated in FIG. 40c, the suggestions dashboard may also display a Down Sell chart that represents the value of all Down Sell deals for each week during the selected month. As illustrated in FIG. 41, the top rank box may display; Top 5 Suggestions Sent; Top 5 Suggestions Viewed; Top 5 Suggestions Accepted Rate.

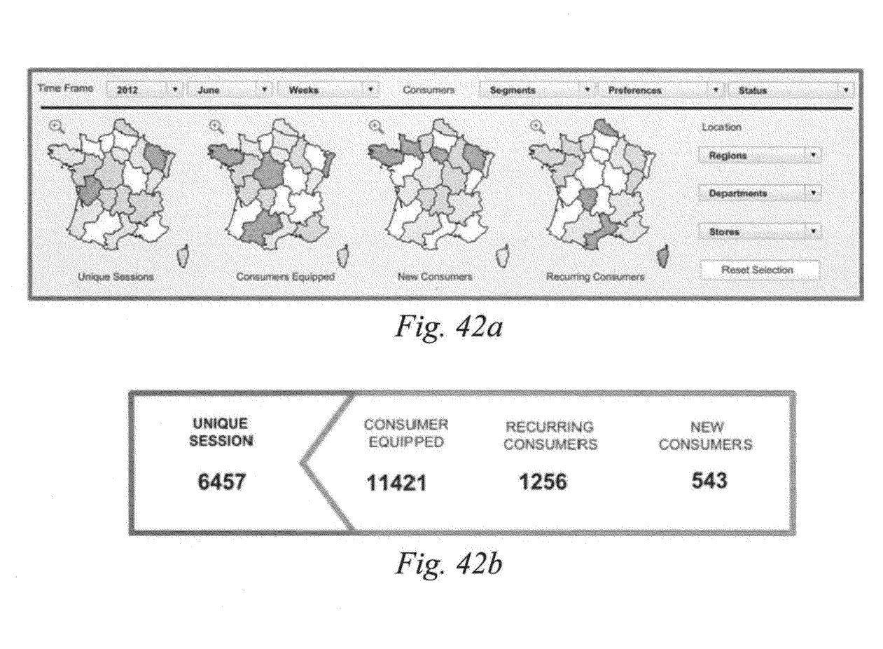

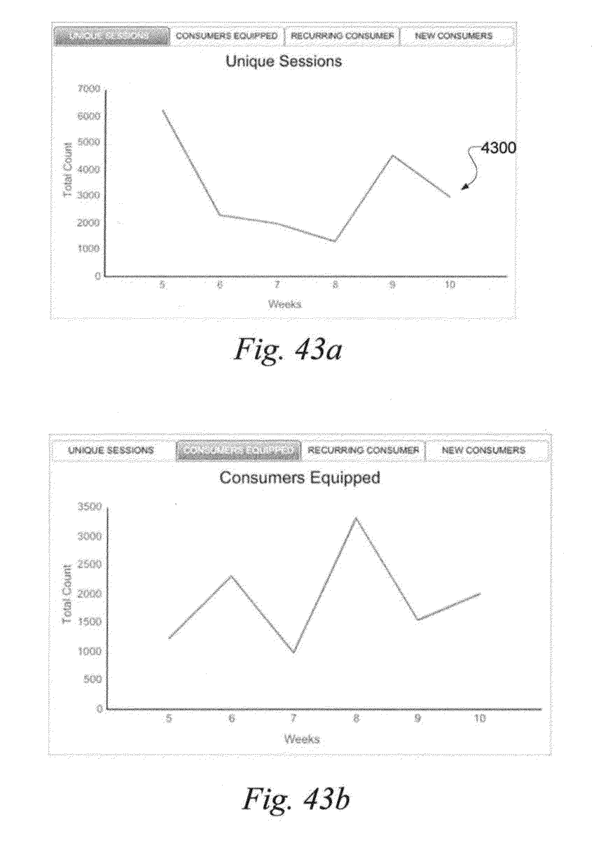

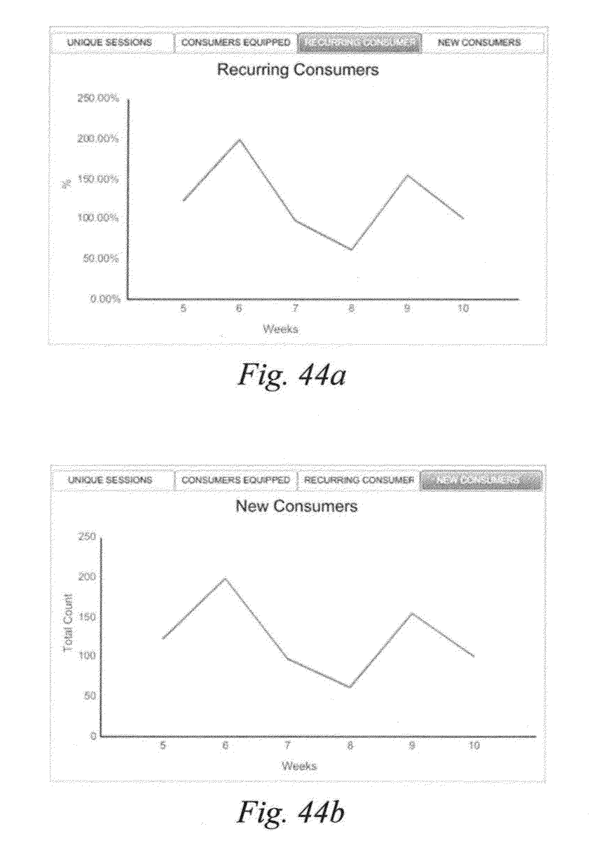

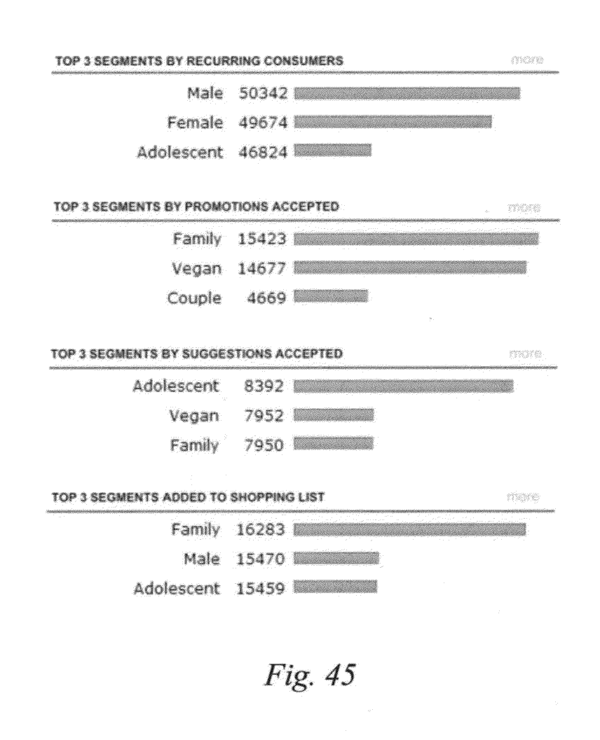

Consumer Dashboard: if the user selects “Consumers” button in main menu 3001, the user is presented with the “Consumers” dashboard. The heat maps in this dashboard give an overview on: Unique Sessions; Total Consumers Equipped; New Consumers; Recurring Consumers (see FIG. 42a). As illustrated in FIG. 42b, the big sales figures box accumulates the overall: Consumer Equipped (Number of consumer equipped with the mobile application); Recurring Consumer Rate (Percentage of returning consumer vs. new consumers); New Consumer (Number of new consumers); Unique Sessions (Total unique sessions). As illustrated in FIG. 43a, the consumers dashboard may also display a Unique Sessions chart that represents the total number of unique sessions for each week during the selected month. As illustrated in FIG. 43b, the consumers dashboard may also display a Consumers Equipped chart that represents the total number of equipped consumers for each week during the selected mouth. As illustrated in FIG. 44a, the consumers dashboard may also display a Recurring Consumers chart that represents the percentage of recurring consumers for each week during the selected month. As illustrated in FIG. 44b, the consumers dashboard may also display a New Consumers chart that represents the total number of new consumers for each week during the selected mouth. As illustrated in FIG. 45, the top rank box displays the: Top 3 Recurring Consumer Segments; Top 3 Segments per Promotion Acceptation Rate; Top 3 Segments per Suggestion Acceptation Rate; Top 3 Segments per Number of Product Scanned.

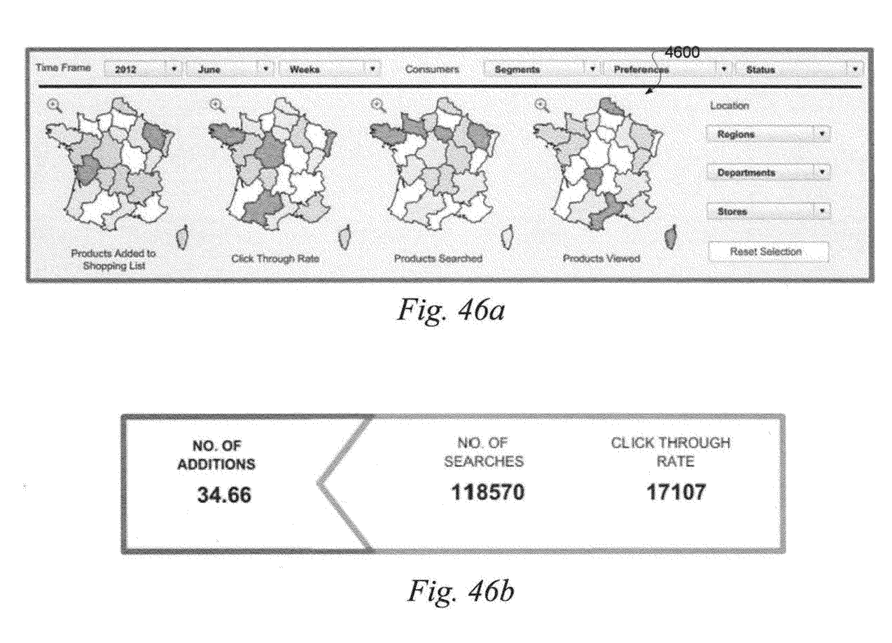

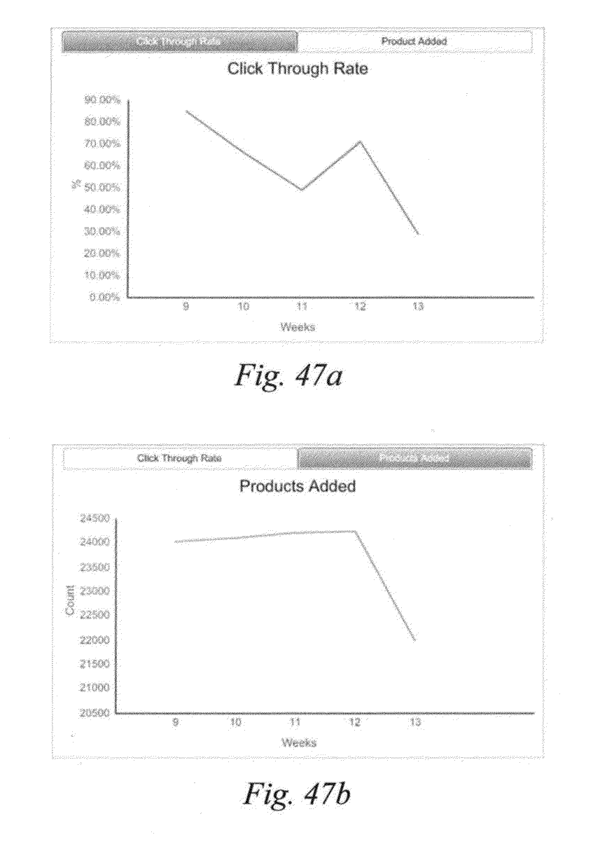

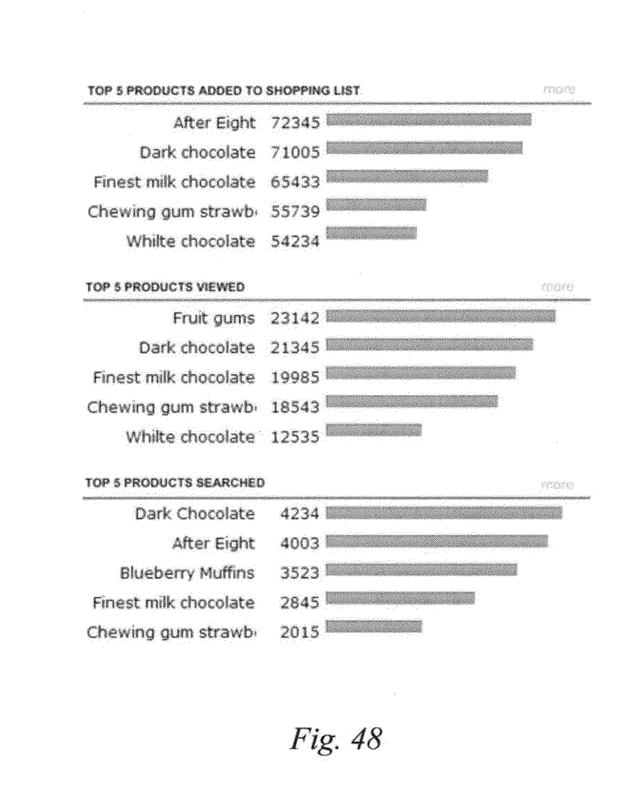

Business Services Dashboard: if the user selects “business services” button in main menu 3001, the user is presented with the “business services” dashboard. The heat maps in this dashboard give an overview on: Products Added to the Shopping List; Click Through Rate; Number of Searches; and Products Viewed (see FIG. 46a). As illustrated in FIG. 46b, the big sales figures box accumulates the overall: No. of Searches (Number of product search); Click Through Rate (Percentage of product added to the shopping list following a search); No. of Additions (Number of product added to the shopping list following a search). As illustrated in FIG. 47a, the business services dashboard may also display a click through rate chart that represents the weekly number of additions to the shopping list as a percentage of the number of items searched for. As illustrated in FIG. 47b, the business services dashboard may also display a products added chart that represents the number of additions of products into the shopping list for each week during the selected month. As illustrated in FIG. 48, the top rank box may display: Top 5 products added; Top 5 products viewed; and Top 5 products searched.

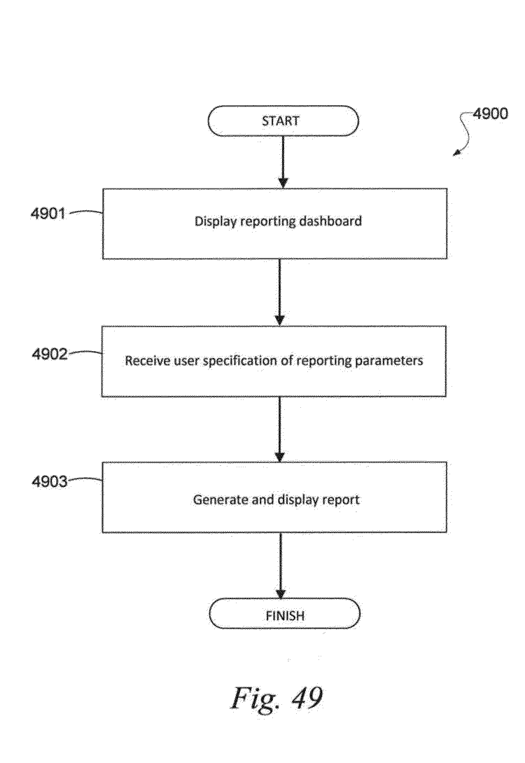

FIG. 49 is a flowchart illustrating an example method 4900, according to various embodiments. The method 4900 may be performed at least in part by, for example, the 200 illustrated in FIG. 2 (or an apparatus having similar modules, such as client machines 110 and 112 or application server 112 illustrated in FIG. 1). In 4901, the reporting module 208 displays a reporting dashboard. In 4902, the reporting module 208 receives a user specification of one or more reporting parameters via the reporting dashboard. In 4903, the reporting module 208 generates and displays, in the reporting dashboard, a report generated in accordance with the user specified reporting parameters. The report may be generated based on user interaction information included in the interaction data tables and ancillary data included in ancillary data tables (see FIG. 5). The report may include various types of data as illustrated in FIGS. 30 through 48.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g. a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g. as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor for implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment an office environment or as a server form), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carder, e.g., in a machine-readable medium for execution by, or to control the operation of, data processing apparatus, e.g., a programmable processor, a computer, or multiple computers.

A computer program can be written in my form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

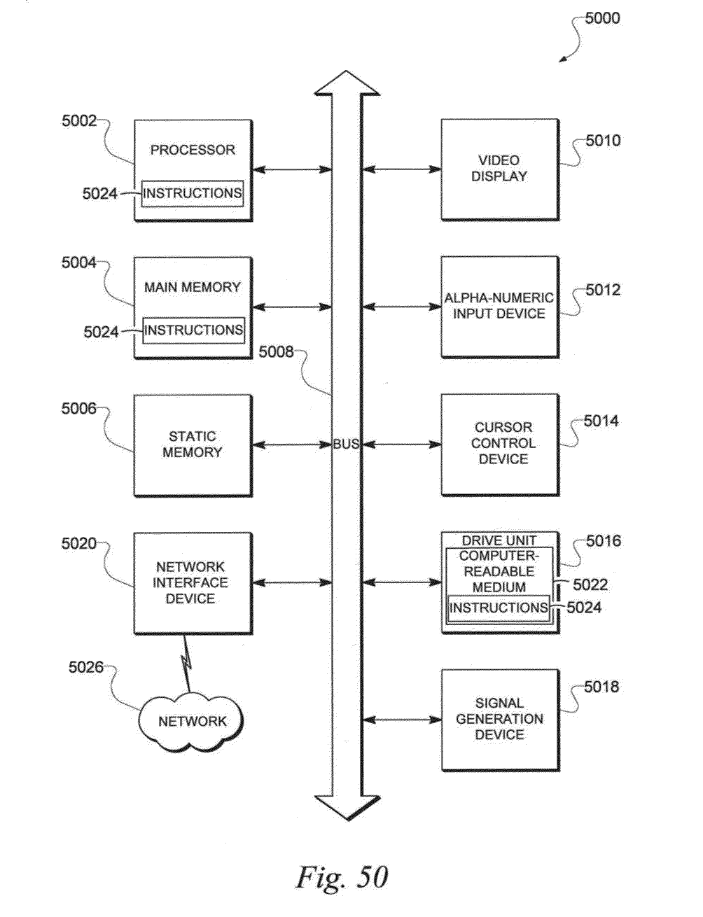

FIG. 50 is a block diagram of machine in the example form of a computer system 5000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 5000 includes a processor 5002 (e.g., a central processing unit (CPU), a graphics processing unit (GPU) or both), a main memory 5004 and a static memory 5006, which communicate with each other via a bus 5008. The computer system 5000 may further include a video display unit 5010 (e.g., a liquid crystal display (LCD) or a cathode ray tube (CRT)). The computer system 5000 also includes an alphanumeric input device 5012 (e.g., a keyboard or a touch-sensitive display screen), a user interface (UI) navigation device 5014 (e.g., a mouse), a disk drive unit 5016, a signal generation device 5018 (e.g., a speaker) and a network interface device 5020.

### Machine-Readable Medium

The disk drive unit 5016 includes a machine-readable medium 5022 on which is stored one or more sets of instructions and data structures (e.g., software) 5024 embodying or utilized by any one or more of the methodologies or functions described herein. The instructions 5024 may also reside, completely or at least partially, within the main memory 5004 and/or within the processor 5002 during execution thereof by the computer system 5000, the main memory 5004 and the processor 5002 also constituting machine-readable media.

While the machine-readable medium 5022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 5024 may further be transmitted or received over a communications network 5026 using a transmission medium. The instructions 5024 may be transmitted using the network interface device 5020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A processor-implemented method comprising:
detecting a mobile interaction event corresponding to a user of a mobile device currently accessing product-related content;
persisting real-time interaction data associated with me mobile interaction event to an interaction data table in real-time, the real-time interaction data including current time information, current user location information, and interaction event information describing the product-related content accessed by the user;
accessing, from one or more ancillary data tables, ancillary data populated into the ancillary data tables at periodic time intervals, the ancillary data including user profile information associated with the user and product information associated with a product described in the product-related content; and
generating, using one or more processors, real-time user context information, based on the real-time interaction data included in the interaction data table and the ancillary data included in the ancillary data tables.

2. The method of claim 1, wherein the user profile information in the one or more ancillary data tables is updated at a first user-adjustable periodic time interval, and the product information in the one or more ancillary data tables is updated at a second user-adjustable periodic time interval.

3. The method of claim 1, further comprising:
receiving a user specification of one or more reporting parameters; and
displaying a report in accordance with the reporting parameters, the reporting being generated based on the real-time interaction data and the ancillary data.

4. The method of claim 1, further comprising:
accessing promotion information included in the ancillary data, the promotion information identifying a plurality of promotions; and
assigning a rating to each of the plurality of promotions based on the real-time user context information, the rating for a given promotion indicating a predicted real-time interest of the user in the given promotion.

5. The method of claim 4, further comprising:
displaying a list of a subset of the promotions on the mobile device, an ordering of the list being determined based on the ratings assigned to the subset of the promotions.

6. The method of claim 5, further comprising:
modifying the ordering of the list, based on user purchase history information included in the user profile information.

7. The method of claim 5, further comprising:
modifying the subset of the promotions, based on user preference information included in the user profile information.

8. The method of claim 5, further comprising:
receiving a user selection of one of the displayed promotions; and
revising user feedback information included in the user profile information to indicate a positive feedback associated with the selected promotion or a negative feedback associated with a non-selected promotion.

9. The method of claim 5, further comprising:
modifying the subset of the promotions, based on user feedback information included in the user profile information.

10. The method of claim 9, wherein the modifying comprises at least one of:
including in the subset a first promotion that is associated with a positive feedback in the user feedback information; and
removing from the subset a second promotion that is associated with a negative user feedback in the user feedback information.

11. An apparatus comprising a context calculation module configured to:
detect a mobile interaction event corresponding to a user of a mobile device currently accessing product-related content;
persist real-time interaction data associated with the mobile interaction event to an interaction data table in real-time, the real-time interaction data including current time information, current user location information, and interaction event information describing the product-related content accessed by the user;
access, from one or more ancillary data tables, ancillary data persisted into the ancillary data tables at periodic time intervals, the ancillary data including user profile information associated with the user and product information associated with a product described in the product-related content; and
generate, using one or more processors, real-time user context information, based on the real-time interaction data included in the interaction data table and the ancillary data included in the ancillary data tables.

12. The apparatus of claim 11, wherein the user profile information in the one or more ancillary data tables is updated at a first user-adjustable periodic time interval, and the product information in the one or more ancillary data tables is updated at a second user-adjustable periodic time interval.

13. The apparatus of claim 11, further comprising a reporting module configured to:
receive a user specification of one or more reporting parameters; and
display a report in accordance with the reporting parameters, the reporting being generated based on the real-time interaction data and the ancillary data.

14. The apparatus of claim 11, further comprising a promotion management module configured to:
access promotion information included in the ancillary data, the promotion information identifying a plurality of promotions; and
assign a rating to each of the plurality of promotions based on the real-time user context information, the rating for a given promotion indicating a predicted real-time interest of the user in the given promotion.

15. The apparatus of claim 14, wherein the promotion management module is further configured to display a list of a subset of the promotions on the mobile device, an ordering of the list being determined based on the ratings assigned to the subset of the promotions.

16. The apparatus of claim 15, wherein the promotion management module is further configured to:
receive a user selection of one of the displayed promotions; and
revise user feedback information included in the user profile information to indicate a positive feedback associated with the selected promotion or a negative feedback associated with a non-selected promotion.

17. The apparatus of claim 15, wherein the promotion management module is further configured to:
modify the subset of the promotions, based on user feedback information included in the user profile information.

18. The apparatus of claim 17, wherein the promotion management module is further configured to:
include in the subset a first promotion that is associated with a positive feedback in the user feedback information; and
remove from the subset a second promotion that is associated with a negative user feedback in the user feedback information.

19. A non-transitory machine-readable storage medium having embodied thereon instructions executable by one or more machines to perform operations comprising:
detecting a mobile interaction event corresponding to a user of a mobile device currently accessing product-related content;
persisting real-time interaction data associated with the mobile interaction event to an interaction data table in real-time, the real-time interaction data including current time information, current user location information, and interaction event information describing the product-related content accessed by the user;
accessing, from one or more ancillary data tables, ancillary data, populated into the ancillary data tables at periodic time intervals, the ancillary data including user profile information associated with the user and product information associated with a product described in the product-related content; and
generating real-time user context information, based on the real-time interaction data included in the interaction data table and the ancillary data included in the ancillary data tables.

20. The storage medium of claim 19, wherein, the user profile information in the one or more ancillary data tables is updated at a first user-adjustable periodic time interval, and the product information in the one or more ancillary data tables is updated at a second user-adjustable periodic time interval.
